(19) United States
(12) Patent Application Publication
(10) Pub. No.: US 2025/0391282 A1
(43) Pub. Date: Dec. 25, 2025

(54) SKILL EVALUATION DEVICE, SKILL EVALUATION METHOD, AND MEDIUM

(71) Applicant: Mitsubishi Electric Corporation, Tokyo (JP)

(72) Inventor: Yuko SUGANUMA, Tokyo (JP)

(73) Assignee: Mitsubishi Electric Corporation, Tokyo (JP)

(21) Appl. No.: 19/308,489

(22) Filed: Aug. 25, 2025

Related U.S. Application Data
(63) Continuation of application No. PCT/JP2023/014641, filed on Apr. 11, 2023.

(51) Int. Cl. G09B 5/02

(52) U.S. Cl. CPC G09B 5/02

(57) ABSTRACT

A skill evaluation device includes: a motion data acquiring unit that acquires motion data indicating a motion of a work, from a sensor that detects the motion of the work being performed by an examinee in work skill evaluation; and a model work analyzing unit that identifies an evaluation item important in evaluating the work of the examinee, on the basis of model-worker motion data indicating a motion of a model worker. Also, the skill evaluation device includes a skill evaluating unit that evaluates the skills of the examinee, on the basis of the motion data acquired by the motion data acquiring unit and the evaluation item identified by the model work analyzing unit.

### CROSS REFERENCE TO RELATED APPLICATION

This application is a Continuation of PCT International Application No. PCT/JP2023/014641, filed on Apr. 11, 2023, which is hereby expressly incorporated by reference into the present application.

### TECHNICAL FIELD

The present disclosure relates to a skill evaluation device, a skill evaluation method, and a medium.

### BACKGROUND ART

There are skill evaluation devices that evaluate work skills of an examinee who is performing work.

As such a skill evaluation device, Patent Literature 1 discloses a device that includes an acquisition unit and a level calculating unit.

The acquisition unit acquires motion data indicating the motion of the work, from a sensor that detects the motion of the work being performed by the examinee. The level calculating unit compares the motion data acquired by the acquisition unit with motion data indicating the motion of a model worker (this motion data will be hereinafter referred to as “model-worker motion data”), and calculates a skill level of the worker on the basis of the result of the comparison between the motion data acquired by the acquisition unit and the model-worker motion data.

### CITATION LIST

### Patent Literature

Patent Literature 1: JP 2020-34849 A

### SUMMARY OF INVENTION

### Technical Problem

There are important evaluation items in evaluating the work being performed by an examinee. Examples of the important evaluation items include an evaluation item regarding the motion of the examinee and an evaluation item regarding how to proceed with the work. When the difference between the examinee's motion related to an important evaluation item and the model worker's motion related to the important evaluation item is large, the skill level of the examinee should receive a low evaluation. On the other hand, the degree of freedom in moving the hands or the degree of freedom in moving the head is high. Therefore, the skill level of the examinee should not receive a low evaluation, just because the difference between the examinee's motion and the model worker's motion related to an evaluation item that is not an important evaluation item is large.

In the device disclosed in Patent Literature 1, the level calculating unit compares the motion of the examinee with the motion of the model worker not only for the evaluation items but also for motions other than the important evaluation items, and therefore, there is a problem in that the accuracy of calculation of the skill level of the examinee will be degraded in some cases.

The present disclosure has been made to solve the problem described above, and aims to obtain a skill evaluation device that can reduce the degradation to be caused in a skill evaluation result by a process of comparison between a motion of an examinee and a motion of a model worker, with respect to a motion that is not an important evaluation item.

### Solution to Problem

A skill evaluation device according to the present disclosure includes processing circuitry configured to: acquire motion data indicating motions of works, acquired by a sensor that detects the motions of the works; extract respective values of first feature amounts from the acquired motion data indicating each of the plural works by a model worker and identify a first feature amount that is an evaluation item for evaluating skill of an examinee, on a basis of variation in respective values of extracted first feature amounts; and evaluate the skill of the examinee, on a basis of the acquired motion data on the works of the model worker, the acquired motion data on the works of the examinee, and the identified first feature amount, and wherein the processing circuitry acquires the motion data indicating motions of the works of each model worker at plural times for each of a plurality of model workers, and wherein the processing circuitry extracts feature amounts with less variation for each model worker from the plural pieces of the motion data of each of the plurality of model workers and identifies a feature amount common to the plurality of model workers from the extracted feature amount as the first feature amount.

### Advantageous Effects of Invention

According to the present disclosure, it is possible to reduce the degradation to be caused in a skill evaluation result by a process of comparison between a motion of an examinee and a motion of a model worker, with respect to a motion that is not an important evaluation item.

### BRIEF DESCRIPTION OF DRAWINGS

FIG. 1 is a configuration diagram showing a skill evaluation device 2 according to a first embodiment.

FIG. 2 is a hardware configuration diagram showing the hardware of the skill evaluation device 2 according to the first embodiment.

FIG. 3 is a hardware configuration diagram of a computer in a case where the skill evaluation device 2 is formed with software, firmware, or the like.

FIG. 4 is a flowchart illustrating a skill evaluation method that involves processing procedures to be carried out by the skill evaluation device 2.

FIGS. 5A and 5B are explanatory diagrams each showing an example of work label data of a model worker.

FIG. 6 is an explanatory diagram showing a difference Dₙ between the position coordinates of a body part in the nth frame and the position coordinates of the body part in the (n+1)th frame.

FIG. 7 is an explanatory diagram illustrating an example of a score calculating system.

FIG. 8 is an explanatory diagram showing results of principal component analysis using model-worker motion data and motion data of an examinee in a two-dimensional feature space.

FIGS. 9A and 9B are explanatory diagrams each showing an example of the model manner in which a model worker proceeds with work.

FIG. 10 is an explanatory diagram showing an example of a model manner in which the model worker proceeds with work.

FIG. 11 is an explanatory diagram showing an example of work label data of the examinee.

FIG. 12 is an explanatory diagram showing an example manner in which the examinee proceeds with work.

FIG. 13 is an explanatory diagram showing an example of unnecessary elemental works.

FIG. 14 is an explanatory diagram showing an example of presentation of a skill evaluation result by an evaluation result presenting unit 17.

FIG. 15 is an explanatory diagram showing an example of presentation of a skill evaluation result in a graph format by the evaluation result presenting unit 17.

FIG. 16 is an explanatory diagram showing a list of skill evaluation results.

FIG. 17 is an explanatory diagram showing an example of information indicating a difference between the skills of the examinee and the skills of the model worker.

FIG. 18 is a flowchart showing a process of extracting model-worker motion data in an important section.

FIG. 19 is a flowchart showing a process of identifying evaluation items.

FIG. 20 is a flowchart showing a process of extracting important feature amounts, using model-worker motion data of a plurality of model workers.

FIG. 21 is a flowchart showing a process of identifying evaluation items related to how to proceed with work.

FIG. 22 is a flowchart showing a process of evaluation regarding a motion of the examinee.

FIG. 23 is a flowchart showing another process of evaluation regarding a motion of the examinee.

FIG. 24 is a flowchart showing a process of evaluation regarding how to proceed with work.

FIG. 25 is a configuration diagram showing a skill evaluation device 2 according to a second embodiment.

FIG. 26 is a hardware configuration diagram showing the hardware of the skill evaluation device 2 according to the second embodiment.

FIG. 27 is an explanatory diagram showing a process to be performed by an important section extracting unit 18 to extract important sections.

FIG. 28 is a flowchart showing a process of estimating a hand that is mainly performing work.

FIG. 29 is a configuration diagram showing a skill evaluation device 2 according to a third embodiment.

FIG. 30 is a hardware configuration diagram showing the hardware of the skill evaluation device 2 according to the third embodiment.

FIG. 31 is a flowchart showing a process of identifying evaluation items.

FIG. 32 is a flowchart showing a process of extracting important feature amounts, using model-worker motion data of a plurality of model workers.

FIG. 33 is a flowchart showing a process of evaluation regarding a motion of the examinee.

FIG. 34 is a flowchart showing another process of evaluation regarding a motion of the examinee.

FIG. 35 is a configuration diagram showing a skill evaluation device 2 according to a fourth embodiment.

### DESCRIPTION OF EMBODIMENTS

To explain the present disclosure in greater detail, modes for carrying out the disclosure are described below with reference to the accompanying drawings.

### First Embodiment

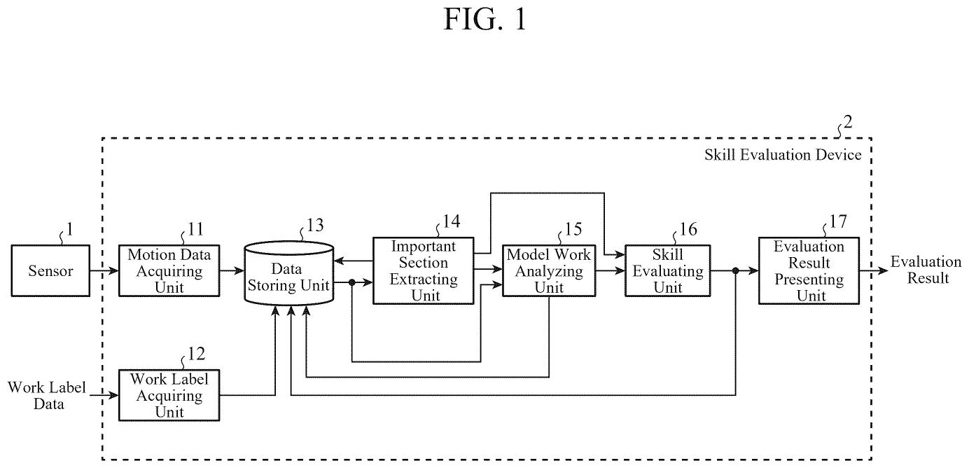

FIG. 1 is a configuration diagram showing a skill evaluation device 2 according to a first embodiment.

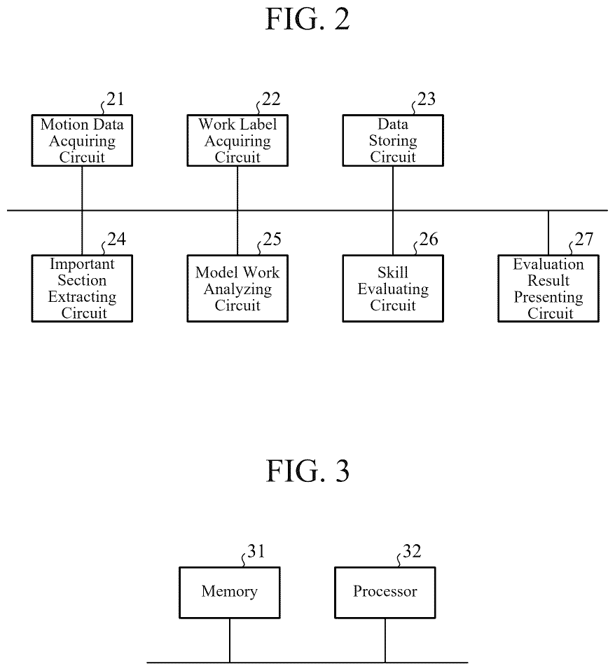

FIG. 2 is a hardware configuration diagram showing the hardware of the skill evaluation device 2 according to the first embodiment.

In FIG. 1, a sensor 1 detects the motion of a work being performed by a model worker of the work, and outputs model-worker motion data indicating the motion of the model worker to the skill evaluation device 2.

Also, the sensor 1 detects the motion of a work being performed by an examinee for work skills, and outputs motion data indicating the motion of the examinee to the skill evaluation device 2.

The skill evaluation device 2 evaluates the skills of the examinee, on the basis of the motion data of the examinee output from the sensor 1 and the model-worker motion data output from the sensor 1.

The skill evaluation device 2 illustrated in FIG. 1 includes a motion data acquiring unit 11, a work label acquiring unit 12, a data storing unit 13, an important section extracting unit 14, a model work analyzing unit 15, a skill evaluating unit 16, and an evaluation result presenting unit 17.

The motion data acquiring unit 11 is formed with a motion data acquiring circuit 21 shown in FIG. 2, for example.

The motion data acquiring unit 11 acquires, from the sensor 1, the model-worker motion data indicating the motion of the work being performed by the model worker.

The motion data acquiring unit 11 acquires, from the sensor 1, the motion data indicating the motion of the work being performed by the examinee.

The motion data acquiring unit 11 outputs both the model-worker motion data and the motion data to the data storing unit 13.

In the skill evaluation device 2 illustrated in FIG. 1, the motion data acquiring unit 11 acquires not only the motion data of the examinee but also the model-worker motion data from the sensor 1. Note that this is merely an example, and, in a case where the model-worker motion data is stored in the data storing unit 13, the motion data acquiring unit 11 may acquire only the motion data of the examinee from the sensor 1, without acquiring the model-worker motion data.

In the skill evaluation device 2 illustrated in FIG. 1, it is assumed that the motion data of the examinee acquired by the motion data acquiring unit 11 indicates the motion of each work of a plurality of works (hereinafter referred to as “elemental works”) included in maintenance work or the like that is the work being performed by the examinee. The model-worker motion data acquired by the motion data acquiring unit 11 is assumed to indicate the motion of each elemental work of the plurality of elemental works included in the maintenance work or the like being performed by the model worker. Note that this is an example, and the motion data of the examinee acquired by the motion data acquiring unit 11 may indicate the motion of one elemental work. Also, the model-worker motion data acquired by the motion data acquiring unit 11 may indicate the motion of one elemental work.

An example of evaluation of the skills of the examinee for maintenance work for adjusting a certain screw among a plurality of screws is described herein. Note that the work about which the skills of the examinee are to be evaluated is not necessarily the maintenance work of adjusting a screw, but may be a maintenance work for a part other than a screw. Also, the work about which the skills of the examinee are to be evaluated is not necessarily a maintenance work, but may be an assembly work in the production line, an inspection work, a manual work for a traditional craft or the like, or a daily work, for example.

The work label acquiring unit 12 is formed with a work label acquiring circuit 22 shown in FIG. 2, for example.

The work label acquiring unit 12 acquires work label data for distinguishing motions of a plurality of elemental works, and outputs the work label data to the data storing unit 13.

The work label data includes data for distinguishing motions of a plurality of elemental works performed by the model worker, and data for distinguishing motions of a plurality of elemental works performed by the examinee. The work label acquiring unit 12 acquires the work label data of both workers.

The data storing unit 13 is formed with a data storing circuit 23 shown in FIG. 2, for example.

The data storing unit 13 acquires both the model-worker motion data and the motion data of the examinee from the motion data acquiring unit 11, and stores both the model-worker motion data and the motion data of the examinee.

The data storing unit 13 acquires the work label data of the model worker and the work label data of the examinee from the work label acquiring unit 12, and stores the work label data of both workers.

Also, the data storing unit 13 stores a result of skill evaluation performed by the skill evaluating unit 16.

The important section extracting unit 14 is formed with an important section extracting circuit 24 shown in FIG. 2, for example.

The important section extracting unit 14 acquires, from the data storing unit 13, each piece of the model-worker motion data, the motion data of the examinee, the work label data of the model worker, and the work label data of the examinee.

The important section extracting unit 14 acquires the time sections in which the respective elemental works indicated by the model-worker motion data have been performed, on the basis of the work label data of the model worker.

The important section extracting unit 14 then extracts the model-worker motion data in sections important in terms of work from the model-worker motion data, on the basis of temporal changes in the model-worker motion data.

Specifically, on the basis of temporal changes in the motions of the respective elemental works indicated by the model-worker motion data, the important section extracting unit 14 extracts the model-worker motion data in sections important in the respective elemental works from the model-worker motion data indicating the motions of the respective elemental works. More specifically, the important section extracting unit 14 extracts the model-worker motion data in the sections in which changes are equal to or smaller than a threshold as the model-worker motion data in the sections important in the elemental works.

The important section extracting unit 14 outputs the model-worker motion data in the sections important in the respective elemental works to the model work analyzing unit 15.

Also, the important section extracting unit 14 acquires the time sections in which the respective elemental works indicated by the motion data of the examinee have been performed, on the basis of the work label data of the examinee.

The important section extracting unit 14 then extracts the motion data in important sections for work from the motion data of the examinee, on the basis of temporal changes in the motion data.

Specifically, on the basis of temporal changes in the motions of the respective elemental works indicated by the motion data of the examinee, the important section extracting unit 14 extracts the motion data in important sections in the respective elemental works from the motion data indicating the motions of the respective elemental works. More specifically, the important section extracting unit 14 extracts the motion data in the sections in which changes are equal to or smaller than a threshold as the motion data in the sections important in the elemental works.

The important section extracting unit 14 outputs the motion data in the sections important in the respective elemental works to the skill evaluating unit 16.

In the skill evaluation device 2 illustrated in FIG. 1, the important section extracting unit 14 extracts the model-worker motion data in the sections in which changes are equal to or smaller than the threshold as the model-worker motion data in the sections important in the elemental works, and extracts the motion data in the sections in which changes are equal to or smaller than the threshold as the motion data of the examinee in the sections important in the elemental works. Note that this is merely an example, and the model-worker motion data in the sections important in the elemental works is not necessarily the model-worker motion data in the sections in which changes are equal to or smaller than the threshold, and the motion data of the examinee in the sections important in the elemental works is not necessarily the motion data in the sections in which changes are equal to or smaller than the threshold.

For example, for a work of scraping off wood with a plane, a work of painting a wall or the like with a brush or a spray, a work of polishing a large workpiece with a polishing machine, or a work of welding two plate-like members with a welding machine, the model-worker motion data or the like in a section important in terms of work may become the model-worker motion data or the like in a section in which a change is equal to or greater than the threshold value.

Note that the threshold in the case of extracting the model-worker motion data or the like in a section in which a change is equal to or smaller than the threshold is different from the threshold in the case of extracting the model-worker motion data or the like in a section in which a change is equal to or larger than the threshold.

The model work analyzing unit 15 is formed with a model work analyzing circuit 25 shown in FIG. 2, for example.

The model work analyzing unit 15 acquires, from the important section extracting unit 14, the model-worker motion data in the sections important in the work.

The model work analyzing unit 15 identifies evaluation items important in evaluating the work of the examinee, on the basis of the model-worker motion data. The evaluation items important in evaluating the work of the examinee include the meaning of an evaluation viewpoint important in evaluating the work of the examinee.

The model work analyzing unit 15 outputs an important evaluation viewpoint to the skill evaluating unit 16.

In the skill evaluation device 2 illustrated in FIG. 1, the model work analyzing unit 15 identifies evaluation items important in evaluating the work of the examinee, on the basis of the model-worker motion data in the sections important in the work as acquired from the important section extracting unit 14. Note that this is merely an example, and the model work analyzing unit 15 may identify evaluation items important in evaluating the work of the examinee, on the basis of the model-worker motion data acquired from the data storing unit 13.

The skill evaluating unit 16 is formed with a skill evaluating circuit 26 shown in FIG. 2, for example.

The skill evaluating unit 16 acquires the motion data of the examinee from the important section extracting unit 14, and acquires the important evaluation items from the model work analyzing unit 15.

The skill evaluating unit 16 evaluates the skills of the examinee, on the basis of the motion data and the evaluation items.

The skill evaluating unit 16 outputs the skill evaluation result to both the evaluation result presenting unit 17 and the data storing unit 13.

In the skill evaluation device 2 illustrated in FIG. 1, the skill evaluating unit 16 evaluates the skills of the examinee, on the basis of the motion data acquired from the important section extracting unit 14 and the evaluation items acquired from the model work analyzing unit 15. Note that this is merely an example, and the skill evaluating unit 16 may evaluate the skills of the examinee, on the basis of the motion data acquired from the data storing unit 13 and the evaluation items.

The evaluation result presenting unit 17 is formed with an evaluation result presenting circuit 27 shown in FIG. 2, for example.

The evaluation result presenting unit 17 acquires a skill evaluation result from the skill evaluating unit 16.

The evaluation result presenting unit 17 presents the result of the skill evaluation performed by the skill evaluating unit 16.

Specifically, the evaluation result presenting unit 17 causes a liquid crystal display (LCD) to display the result of the skill evaluation performed by the skill evaluating unit 16.

In FIG. 1, it is assumed that the motion data acquiring unit 11, the work label acquiring unit 12, the data storing unit 13, the important section extracting unit 14, the model work analyzing unit 15, the skill evaluating unit 16, and the evaluation result presenting unit 17, which are components of the skill evaluation device 2, are formed with dedicated hardware as illustrated in FIG. 2. That is, it is assumed that the skill evaluation device 2 is formed with the motion data acquiring circuit 21, the work label acquiring circuit 22, the data storing circuit 23, the important section extracting circuit 24, the model work analyzing circuit 25, the skill evaluating circuit 26, and the evaluation result presenting circuit 27.

Here, the data storing circuit 23 is a nonvolatile or volatile semiconductor memory such as a random access memory (RAM), a read only memory (ROM), a flash memory, an erasable programmable read only memory (EPROM), or an electrically erasable programmable read only memory (EEPROM), a magnetic disk, a flexible disk, an optical disk, a compact disk, a mini disk, or a digital versatile disc (DVD), for example.

Further, each of the motion data acquiring circuit 21, the work label acquiring circuit 22, the important section extracting circuit 24, the model work analyzing circuit 25, the skill evaluating circuit 26, and the evaluation result presenting circuit 27 is a single circuit, a composite circuit, a programmed processor, a parallel-programmed processor, an application specific integrated circuit (ASIC), a field-programmable gate array (FPGA), or a combination thereof, for example.

The components of the skill evaluation device 2 are not necessarily formed with dedicated hardware, but the skill evaluation device 2 may be formed with software, firmware, or a combination of software and firmware.

Software or firmware is stored as a program in a memory of a computer. A computer means hardware that executes a program, and is a central processing unit (CPU), a graphics processing unit (GPU), a central processor, a processing unit, an arithmetic unit, a microprocessor, a microcomputer, a processor, or a digital signal processor (DSP), for example.

FIG. 3 is a hardware configuration diagram of a computer in a case where the skill evaluation device 2 is formed with software, firmware, or the like.

In a case where the skill evaluation device 2 is formed with software, firmware, or the like, the data storing unit 13 is formed in a memory 31 of the computer. A program for causing the computer to execute each processing procedure in the motion data acquiring unit 11, the work label acquiring unit 12, the important section extracting unit 14, the model work analyzing unit 15, the skill evaluating unit 16, and the evaluation result presenting unit 17 is stored in the memory 31. A processor 32 of the computer then executes the program stored in the memory 31.

Further, FIG. 2 illustrates an example in which each of the components of the skill evaluation device 2 is formed with dedicated hardware, and FIG. 3 illustrates an example in which the skill evaluation device 2 is formed with software, firmware, or the like. Note that this is merely an example, and some components in the skill evaluation device 2 may be formed with dedicated hardware while the remaining components are formed with software, firmware, or the like.

Next, operations to be performed by the skill evaluation device 2 illustrated in FIG. 1 are described.

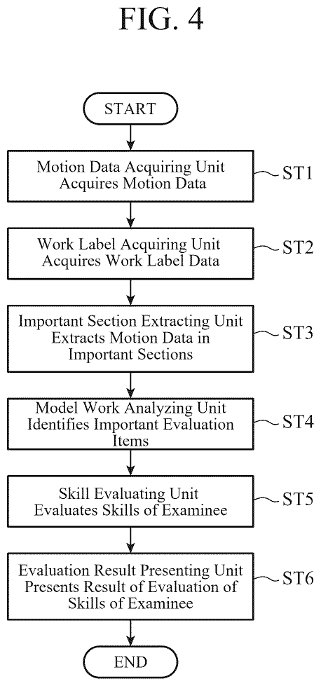

FIG. 4 is a flowchart illustrating a skill evaluation method that involves processing procedures to be carried out by the skill evaluation device 2.

In the following, a maintenance work for adjusting screws is described as an example. There is a plurality of screws, and, when a wrong screw is erroneously adjusted, rework occurs.

When each of the model worker and the examinee performs work at the site of a maintenance work, both the model-worker motion data of the model worker and the motion data of the examinee are stored into a motion data DB (not shown) by a communication device (not shown).

The motion data acquiring unit 11 acquires, from the motion data DB, both the model-worker motion data of the model worker and the motion data of the examinee. Depending on the processing, target motion data of one work or of a plurality of past works is acquired.

The model-worker motion data is data related to motions of the model worker, and is data including position coordinates of the respective parts (the respective joints of the fingers, elbows, arms, feet, and the like, the head, and the like) of the body of the model worker obtained as time-series data. The motion data is data related to motions of the examinee, and is data including position coordinates of the respective parts of the body of the examinee obtained as time-series data. Motions are acquired by a device that detects motions of the model worker and the like, such as a camera, a velocity sensor, a magnetic sensor, an infrared sensor, or a human detecting sensor, and are stored into the motion data DB via a communication device. It can be obtained from a sensor attached to the body, a sensor installed in the work target instrument or a tool to be used, an image or a video image captured by a camera, or the like.

The motion data and the like may be obtained by a method by which a personal computer or the like that is another device acquires data in real time and stores the acquired result data into the motion data DB of the work evaluation device using a recording medium such as a DVD, other than a method of communicating directly with a sensor, an imaging device such as a camera, or the like. The method for acquiring the motion data is not limited to the above, but may be any appropriate method.

In the first analysis, one model worker is determined, and model-worker motion data of the model worker in a plurality of works is acquired.

The work label acquiring unit 12 acquires the work label data to be used in the analysis.

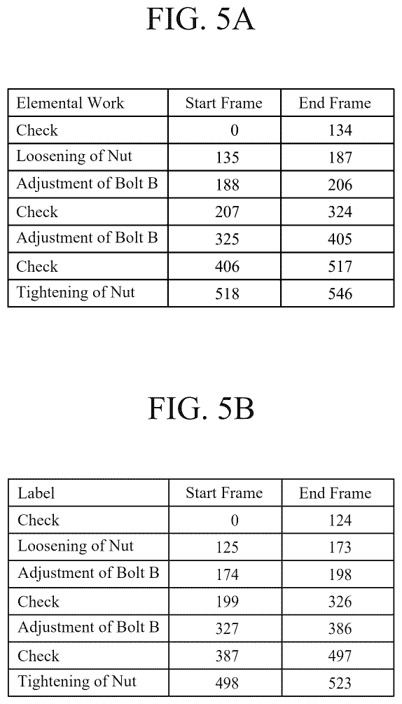

FIG. 5A illustrates an example of work label data of a maintenance work.

The “labels” distinguish the respective elemental works. Although the text is in Japanese in the example in FIG. 5A, numbers can be used as the work IDs, alphabetical names for the elemental works and the like can also be used, and any appropriate text can be used.

The “start frames” and the “end frames” are the frames at the start times and the frames at the end times of the respective elemental works. Although the frames are used as units in FIG. 5A, the work label data is data associating which elemental work has been performed in which time section with the motion data (time-series data), and therefore, times may be used as units. In this case, the start times and the end times are used. Any appropriate time unit may be used.

As illustrated in FIG. 5A, depending on the type of elemental work, there is an elemental work to be performed a plurality of times in one maintenance work.

If the model worker gives some sign at the timing of starting each elemental work and the timing of ending each elemental work, for example, an external device (not shown) can generate work label data on the basis of the signs from the model worker, for example.

Here, the external device generates the work label data, on the basis of signs from the model worker. Note that this is merely an example, and an external device or the like may generate the work label data by analyzing model motions detected by the sensor 1, for example. Specifically, the external device or the like may generate the work label data by estimating the correspondence relationship between each section and the elemental works, using a clustering technique such as a state transition probability model, a Bayesian model, a Markov model, a hidden Markov model, a multi-class identifying model, a kernel function, or a dynamic time warping. Also, the external device or the like may generate the work label data by estimating the correspondence relationship between each section and the elemental works, using deep learning.

The important section extracting unit 14 receives model-worker motion data of a certain model worker who is the target model from the motion data acquiring unit 11 for a plurality of times of trials, and receives the corresponding work label data for a plurality of times of trials from the work label acquiring unit 12. The important section extracting unit 14 then extracts the sections (important sections) in which the posture is steady by excluding the time sections in the middle of movement the body (a hand, the head, a foot, or the like) before reaching a fixed position, as sections particularly important in terms of work among time sections defined by the start frames and the end frames in the work label data for each elemental work.

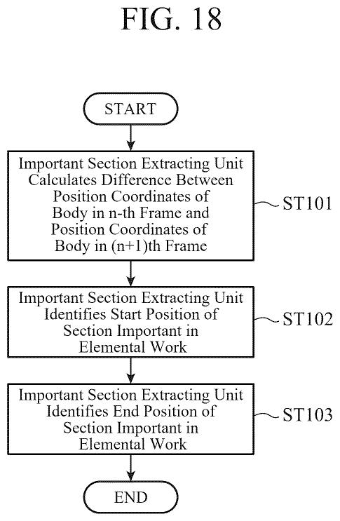

FIG. 18 shows the flow of a process to be performed by the important section extracting unit 14. The procedures in FIG. 18 are the processing flow of each elemental work (corresponding to one row of the work label data in FIG. 5A). In a case where the target elemental work has been performed a plurality of times in one maintenance work as in “adjustment of bolt B” in FIG. 5A, the important sections are extracted through the procedures shown in FIG. 18 each time.

In ST101, a difference from the previous frame is calculated using a variable. Since the target work in the first embodiment is a maintenance work of adjusting screws, the difference in the position coordinates of a hand of the model worker from the previous frame is calculated using the position coordinates of the palm among the coordinates of the respective portions of the model-worker motion data, for example.

In ST102, the start position of an important section is determined to be the position of the first frame among a predetermined number of successive frames in which the result calculated in ST101 is smaller than a threshold, while the window having a predetermined width is shifted from the top frame.

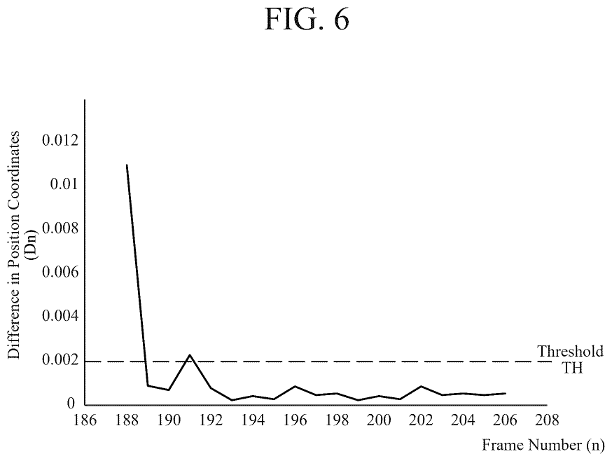

A specific example is shown in FIG. 6. FIG. 6 illustrates a result of calculation in ST101 of the displacement of the position coordinates of the palm in the previous frame, for a time section related to the label of “adjustment of bolt B” in the work label data shown in FIG. 5A. In a case where the threshold is set to 0.002, and the predetermined frames are set to two frames, the window is shifted one frame at a time by a window size of two frames from the start frame 188 of the work label data, and a position where all the two frames in the window are smaller than the threshold is searched for. Here, a and b represent the respective window sizes of the two frames. All the frames in the target window are equal to or smaller than the threshold at the position of frame 192, and therefore, the start position of an important section is determined to be the position of frame 192.

In ST103, the end position of the important section is determined to be the position of the last frame among the predetermined number of successive frames in which the result calculated in ST101 is smaller than the threshold, while the window is shifted one frame at a time from the last frame toward the top frame.

This is a process in which the search direction is reverse to that in ST102, and the search method is the same as that in ST101.

In FIG. 6, all the values in the window are smaller than the threshold in the first window (the window of frames 204 to 206), and accordingly, the end position of the important section is determined to be frame 206.

Although a processing flow has been described using the label “adjustment of bolt B” as an example in the above description, the important section is extracted in the same manner as above for each elemental work corresponding to one row of the work label data regarding the other elemental works.

Note that, in the above example operation, the difference from the position coordinates in the previous frame is calculated using the position coordinates of the palm in ST101. However, the variable to be used is not limited to the palm. Also, the value to be calculated is not necessarily a difference in position coordinates.

The important section extracted by the important section extracting unit 14 is stored into the data storing unit 13, and is transferred to the model work analyzing unit 15 and the skill evaluating unit 16.

The model work analyzing unit 15 receives the model-worker motion data of a plurality of maintenance works from the motion data acquiring unit 11 via the data storing unit 13, receives the work label data of the plurality of maintenance works corresponding to the model-worker motion data from the work label acquiring unit 12 via the data storing unit 13, and, after receiving the important sections calculated for the respective time sections from the important section extracting unit 14, analyzes the plurality of maintenance works performed by the model worker and extracts evaluation items that are important points in the work.

Receiving the motion data for the plurality of maintenance works from the motion data acquiring unit 11 and receiving the corresponding work label data of the plurality of maintenance works from the work label acquiring unit 12, the model work analyzing unit 15 extracts feature amounts having less variation in a plurality of trials and extracts the feature amounts related to an important point in terms of work (the feature amounts will be hereinafter referred to as important feature amounts).

There are the following two types of methods for extracting important feature amounts.
a. A method of extraction from the model-worker motion data and the work label data of one model worker
b. A method of extraction from the model-worker motion data and the work label data of a plurality of model workers

The user inputs which one of a and b is selected. This is performed by a method of writing in a setting file, a method of inputting from a keyboard or the like, for example. The method is not limited to this.

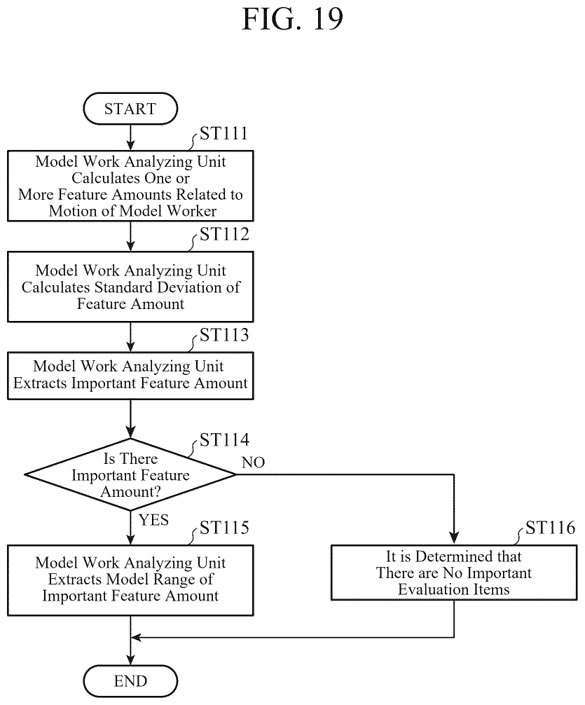

FIG. 19 shows a processing flow according to a method of extracting important feature amounts using the model-worker motion data of one model worker by the above method a in the flow of a process to be performed by the model work analyzing unit 15.

In ST111, the feature amounts are calculated for the important section in each trial of the target elemental work (for each row of the work label data) using the acquired model-worker motion data and work label data of a plurality of maintenance works. As an example of the feature amounts, statistics (a maximum value, a minimum value, and the like) with respect to position, velocity, or the like are calculated using an arbitrary variable. However, the feature amounts are not limited thereto, and any appropriate feature amounts can be used.

“Each trial of the target elemental work” corresponds to each row in the work label data of the target elemental work. For example, when the target elemental work is “adjustment of bolt B” in a case where the work label data of FIG. 5A is used, the feature amounts are calculated for the important section extracted by the important section extracting unit 14 for each (each trial) of the first adjustment (from frame 188 to frame 206) and the second adjustment (from frame 325 to frame 405).

As a specific example of the feature amounts, in a case where feature amounts related to the velocity of a palm are calculated, for example, the velocity is calculated on the basis of the difference from the previous frame using the position coordinates of the palm in an important section of the target trial, and the maximum value, the minimum value, and the like of the velocity in the important section are calculated as the feature amounts.

In ST112, a standard deviation in the plurality of trials is calculated for each feature amount calculated in ST111.

For example, in a case where the work label data in FIG. 5A is used, when the target elemental work is “adjustment of bolt B”, feature amounts are obtained from trial data of a total of two sets of the feature amounts calculated from the important section of the first adjustment (from frame 188 to frame 206) and the feature amounts calculated from the important section of the second adjustment (from frame 325 to frame 405) (sets of feature amounts in two trials are obtained).

Likewise, in a case where the work label data in another maintenance work is the data in FIG. 5B, feature amounts related to “adjustment of bolt B” are obtained from trial data of a total of two sets of the feature amounts calculated from the important section of the first adjustment (from frame 174 to frame 198) and the feature amounts calculated from the important section of the second adjustment (from frame 327 to frame 386). In this manner, in a case where the work label data (FIGS. 5A and 5B) of two maintenance works is used, feature amounts of four trials are obtained with respect to “adjustment of bolt B”.

In ST113, feature amounts with less variation are extracted in the plurality of trials, and are regarded as important feature amounts that are evaluation items important in terms of work. As the feature amounts with less variation, feature amounts whose standard deviations calculated in ST112 are equal to or smaller than a threshold are extracted. The threshold is defined in a setting file, or is given by an input through a mouse, a keyboard, or the like. Any other method may be used.

In ST114, a check is made to determine whether there is an important feature amount. In a case where standard deviations are used, if there are no feature amounts whose standard deviations are equal to or smaller than the threshold, it is determined that there are no important feature amounts, and there are no evaluation items important in terms of work (ST116).

If there is an important feature amount, a model range of the important feature amount is extracted from the model-worker motion data of the model worker in ST115. For example, in a case where the important feature amount is the “maximum value of the palm velocity”, a possible range (from the minimum value to the maximum value) of the “maximum value of the palm velocity” is acquired from the model-worker motion data of the target model worker used in the analysis, and the range is set as the model range of the important feature amount. Model ranges are extracted on the basis of the number of important feature amounts and each important feature amount.

In this manner, the important evaluation items in terms of work are obtained from the analysis of the model worker motion data of the model worker.

Further, the above example operation is an example operation in which it is determined that there are no important feature amounts when there are no feature amounts whose standard deviations are equal to or smaller than the threshold in ST116, but the determination method is not limited to this method. By another method, the number of feature amounts whose standard deviations are equal to or smaller than the threshold may be obtained, and it may be determined that there are no important feature amounts when the number is small (equal to or smaller than a threshold). Alternatively, a method that does not use standard deviations may be adopted.

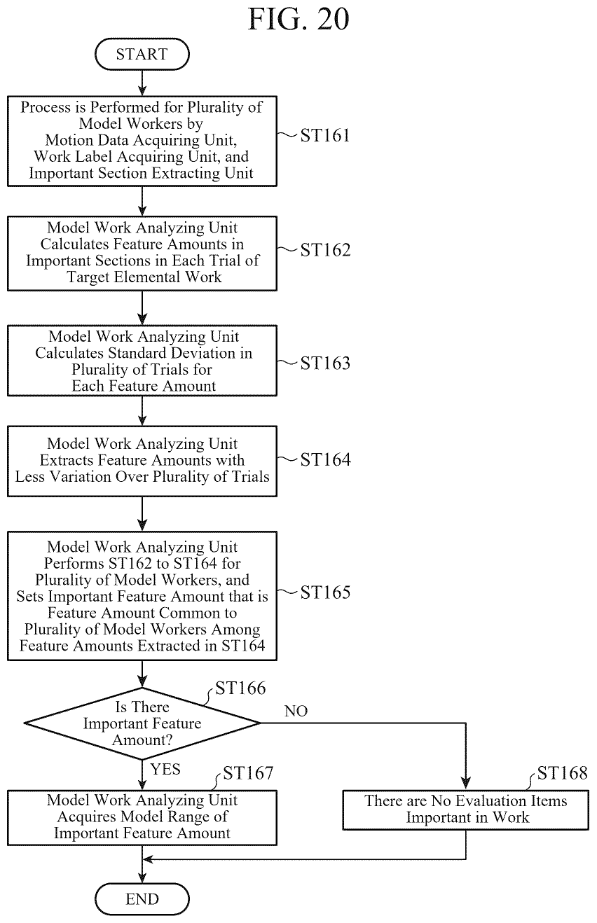

Next, a processing flow in which important feature amounts are extracted using the model-worker motion data of a plurality of model workers is shown in FIG. 20.

In ST161, each process (by the motion data acquiring unit 11, the work label acquiring unit 12, and the important section extracting unit 14) prior to the process to be performed by the model work analyzing unit 15 is performed with respect to the plurality of model workers. The details of the process are the same as described above. The model workers to be used for analysis are defined in a setting file, or are input by the user using a keyboard, a mouse, or the like. Some other method may be adopted.

ST162 and ST163 are the same operations as ST111 and ST112 in FIG. 19, respectively.

In ST164, feature amounts with less variation in a plurality of trials are extracted. As in the operation in ST113 in FIG. 19, the feature amounts whose standard deviations are equal to or smaller than a threshold are extracted as the feature amounts with less variation in a plurality of trials.

Note that, although the extraction results are set as the important feature amounts in ST113 in FIG. 19, the extraction results of feature amounts with less variation are not regarded as the important feature amounts at the stage of the process in ST164 in the case of FIG. 20 using data of a plurality of model workers.

In ST165, ST162 to ST164 are performed with respect to the plurality of model workers, and the feature amounts common to the plurality of model workers among the feature amounts extracted in ST164 are set as the important feature amounts.

The processes and operations in ST166, ST167, and ST168 are the same as those in ST114, ST115, and ST116 in FIG. 19, respectively.

The extraction results of the important feature amounts and the results of the respective feature amounts and the model ranges in a case where there are important feature amounts are stored into the data storing unit 13 and are delivered to the skill evaluating unit 16.

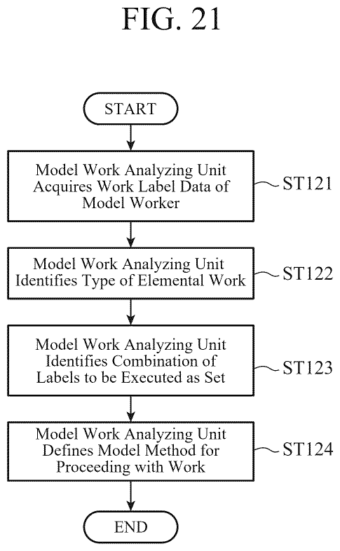

The model work analyzing unit 15 analyzes how to proceed with the entire work using the work label data of the model worker, and defines how to proceed with work without leaving necessary elemental works undone and without rework as a model work progress. The processing flow is shown in FIG. 21.

In ST121, the work label data of an analysis target person is acquired. For example, the work label data of the two maintenance works illustrated in FIGS. 5A and 5B is acquired.

In ST122, the type of label is extracted on the basis of the value of the column “label” in the work label data.

In the case of the work label data in FIGS. 5A and 5B, the four types of “check”, “loosening of nut”, “adjustment of bolt B”, and “tightening of nut” are extracted.

In ST123, the relationships with the preceding and subsequent labels are examined with respect to each label type, and a combination of labels to be performed as a set is extracted. As a result, regarding “adjustment of bolt B” in FIGS. 5A and 5B, “check” is performed after “adjustment of bolt B” in all cases, and “adjustment of bolt B” and “check” are extracted as a set combination.

In ST124, the order of appearances of the labels and the number of repetitions of the elemental work that is successively repeated are extracted, and model progress is defined. The set of “adjustment of bolt B” and “check” extracted in ST123 is repeated twice in a row, and “2” is extracted as the number of repetitions.

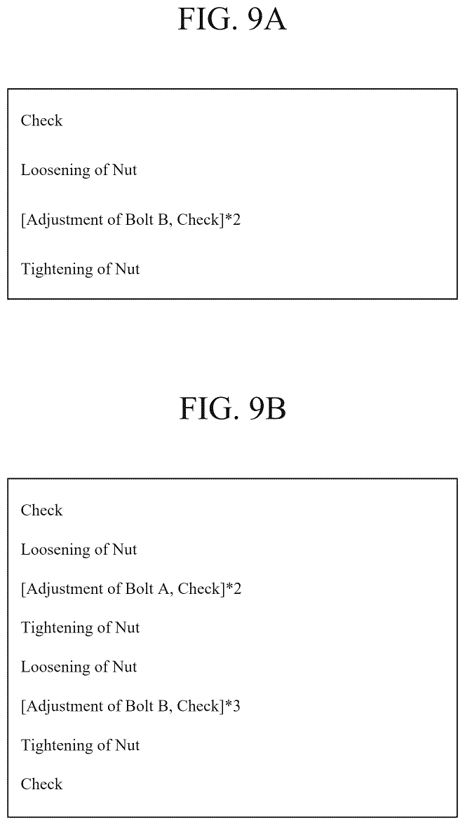

Further, an example in which model progress is defined from the order of appearances of the labels is illustrated in FIG. 9A.

The chart means that the work is performed in the order shown from the top toward the bottom, and [ ] collectively indicates the elemental works to be performed as a set. [Adjustment of bolt B, check] means that a check is performed after adjustment of the bolt B, and [adjustment of bolt B, check]*2 means that a check is repeated twice after adjustment of the bolt B.

FIG. 9A illustrates how to proceed with work on the one type of bolt B as the type of bolt. However, in the case of a work in which there are the two types of bolts A and B, and adjustment of the bolt A is performed prior to adjustment of the bolt B, model progress with work is defined as illustrated in FIG. 9B by analysis of the work label data in the same manner. This means that the set of “bolt adjustment and check” is repeated twice for both the bolt A and the bolt B.

Note that the definition regarding how to proceed with work is not necessarily in the formats shown in FIGS. 9A and 9B. Definition may be in some other format, as long as the necessary elemental works and the execution order thereof, and a set of elemental works to be invariably performed as a set are easy to understand, and the number of repetitions is easy to understand if there is a set of elemental works to be repeatedly performed.

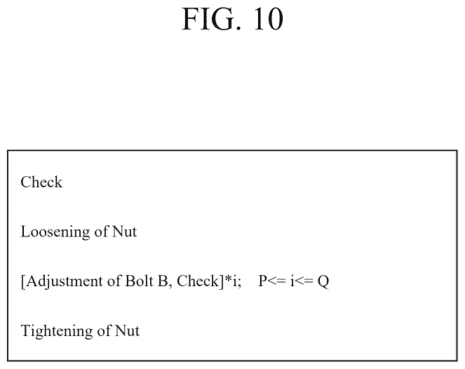

FIGS. 9A and 9B show examples in which the number of repetitions of “adjustment of bolt A (or B) and check” is two. However, in a case where the number of repetitions is in the range of N times or more and M times or less, for example, the number of repetitions is defined as shown in FIG. 10.

The generated definition regarding how to proceed with work is stored into the data storing unit 13, and is delivered to the skill evaluating unit 16.

The skill evaluating unit 16 quantitatively evaluates the skills of the examinee, using the motion analysis result extracted by the model work analyzing unit 15 and the model work progress extracted by the model work analyzing unit 15.

A plurality of maintenance works may be collectively evaluated, or only one maintenance work may be evaluated as the target.

The two viewpoints of motions and how to proceed with work are comprehensively evaluated.

First, evaluation regarding motions is described.

The following two types of evaluation methods can be adopted.
a. Method of evaluation using the model range of an important feature amount extracted by the model work analyzing unit 15
b. Method of evaluation by vectorizing important feature amounts extracted by the model work analyzing unit 15

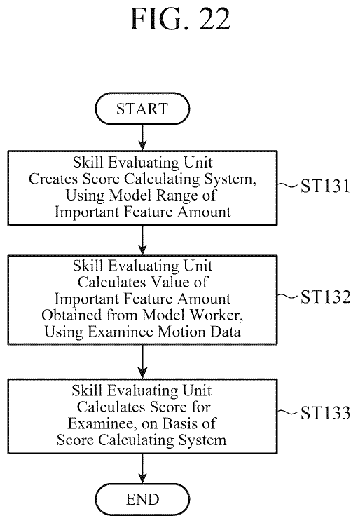

As for the method a, a process of calculating a score using a model range of the important feature amount is illustrated in FIG. 22.

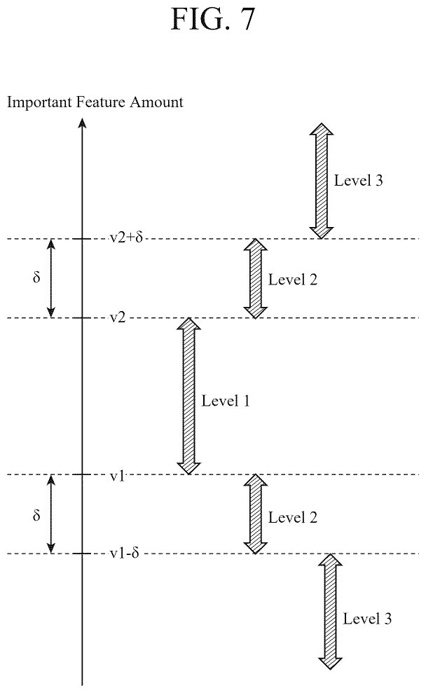

In ST131, a score calculating system is created using the model range of the important feature amount. An example is illustrated in FIG. 7.

FIG. 7 illustrates an example in which, when one of the important feature amounts extracted by the model work analyzing unit 15 is “important feature amount A”, and the model range extracted by the model work analyzing unit 15 is from v1 to v2, scores are calculated by roughly dividing the levels into three stages. When the score is closer to the model range of the important feature amount A, the motion is regarded as being closer to the model motion, and level 1, level 2, and level 3 are defined in descending order of scores. For example, 100 points are given at level 1, which is the model range, 80 points are given at level 2, which is close to the model range, and a score is calculated in the range at level 3 using an attenuation function so that the score is lower at a position farther away from the model range. Width δ can be set to any appropriate value.

The method of calculating a score is not limited to the above method. For example, scoring can be performed by two determinations as to pass/fail, such as passing (100 points) when the range of the important feature amount is the model range, and failing (0 points) when the range is some other range.

Also, as for a range other than the model range from v1 to v2 of the important feature amount, the score may be calculated so that the score is lower at a position farther away from the model range.

Further, a range other than the model range from v1 to v2 of the important feature amount may be divided into four ranges, and five-grade evaluation in total may be performed. The score calculation method and the level division may be other than the above.

In ST132, a value of the important feature amount obtained from the model worker is calculated using motion data of the examinee. Specifically, the motion data acquiring unit 11 acquires motion data of the examinee, the work label acquiring unit 12 acquires the work label data corresponding to motion data of the examinee, and the important section extracting unit 14 extracts sections important in terms of work (important sections). Specific operations and the details of the processes are the same as those described above. Using these results, the value of each important feature amount in the important sections is calculated in each trial of the elemental work.

For example, in a case where there are two types of important feature amounts, which are the maximum value of the velocity of the palm and the minimum value of the velocity of the palm, the values of these two types of feature amounts in the important sections are calculated using motion data of the examinee.

In ST133, a score for the examinee is calculated, on the basis of the score calculating system created in ST131.

For example, in a case where the value of the important feature amount A calculated from motion data of the examinee corresponds to level 1 in FIG. 7 (within the range from v1 to v2), 100 points are given.

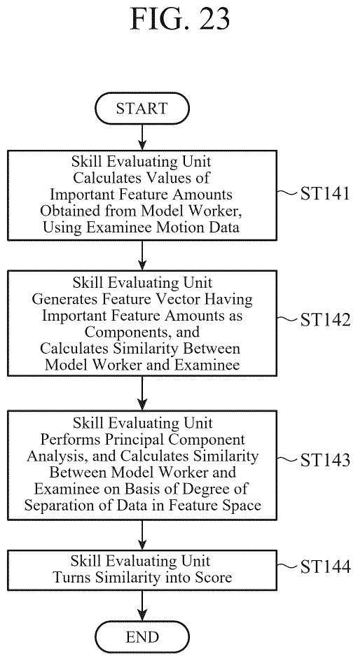

Next, a process of calculating a score by the method b is described. The processing flow is shown in FIG. 23.

In ST141, values of important feature amounts obtained from the model worker are calculated using the motion data of the examinee. The process and the details of the operation are the same as those in ST132 in FIG. 22.

In ST142, feature vectors having important feature amounts as components are generated, and the similarity between the model worker and the examinee is calculated. For example, in a case where the important feature amounts are the two types of the maximum value of the velocity of the palm and the minimum value of the velocity of the palm, feature vectors having these two types of values as components are generated for both the model worker and the examinee, and the cosine similarity between the feature vectors is calculated.

In ST143, principal component analysis is performed using the calculation result of the important feature amounts in the data of the model worker and the examinee, and the similarity between the model worker and the examinee is calculated on the basis of the degree of separation of the data in the feature space.

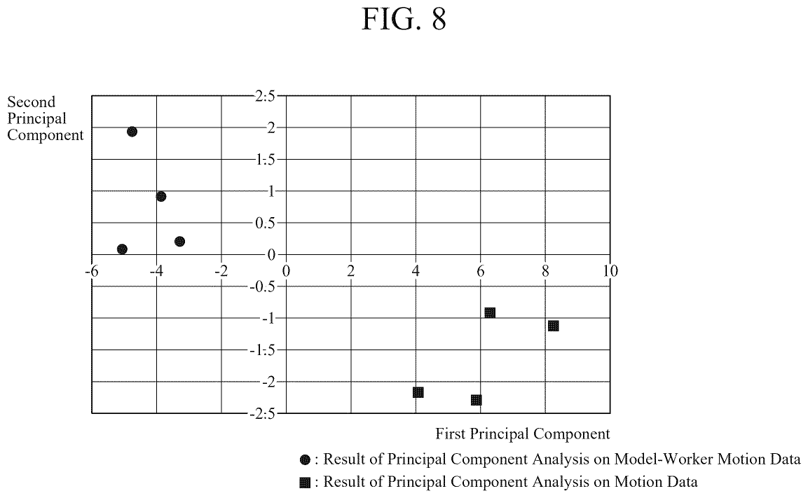

An example is now described with reference to FIG. 8. FIG. 8 illustrates an example in which calculation results of important feature amounts for the model worker and the examinee are standardized and subjected to principal component analysis, and a first principal component is plotted on the x-axis while a second principal component is plotted on the y-axis. Round marks indicate results of the model worker, and square marks indicate results of the examinee. The results of each worker is trial data of four trials. The results of calculation of the important feature amounts are acquired from the model work analyzing unit 15. As for the examinee, the results are acquired in ST141.

As a method of calculating the degree of separation of data in the feature space in which the first principal component is the x-axis while the second principal component is the y-axis, it is possible to use a method based on the distance between the center of gravity of the plurality of pieces of data of the model worker and the center of gravity of a plurality of pieces of data of the examinee, a method based on the point at which the distance between the data of the model worker and the data of the examinee is shortest, a method based on the point at which the distance between the data of the model worker and the data of the examinee is longest, a method of combining two or more of these methods, or the like. The similarity between the model worker and the examinee is calculated on the basis of the degree of separation of data in the feature space by a method of performing calculation to set the similarity to 1.0 when the distance is equal to or shorter than a threshold, and set the similarity to a value that is smaller when the distance is longer, or by a method of performing calculation to set the similarity to a value that is smaller when the distance is longer, without setting any threshold.

In ST144, scoring is performed on the basis of the similarities calculated in ST142 and ST143. For example, the average score can be calculated by giving scores to the similarities in ST142 and ST143, with the maximum of similarity based on ST142 being M points, the maximum of similarity based on ST143 being N points. As another method, there is a method of calculating an average of the similarity calculated in ST142 and the similarity calculated in ST143, and giving scores to the calculation results on the basis of a similarity maximum of 1.0.

In FIG. 8, the operation of giving a score to the motion of the examinee using two types of the similarity (ST142) calculated using the feature vector and the similarity (ST143) calculated from the result of the principal component analysis has been described. However, the similarity is not limited to the above two types, and some other methods can be used. Further, it is not necessary to use both of the two types, and it is possible to use only one of the two types. Alternatively, similarities may be calculated by some other methods, and results of similarities calculated by three or more kinds of methods may be taken into consideration.

Furthermore, the method of giving scores to similarities in ST144 is not limited to the above-described method.

Next, evaluation regarding how to proceed with work in the skill evaluating unit 16 is described.

In the example described below, there are two types of targets to be subjected to maintenance work, which are the bolt A and the bolt B, and the examinee adjusts both the bolt A and the bolt B, though the work of adjusting only the bolt B is correct.

The model manner of proceeding with work is shown in FIG. 9A, which is assumed to be how to proceed with work defined from the work label data of the model worker shown in FIG. 5A. By a model method of proceeding with work, a check is first performed, a nut is then loosened, a set of “adjustment of bolt B and check” is performed twice, and the nut is tightened.

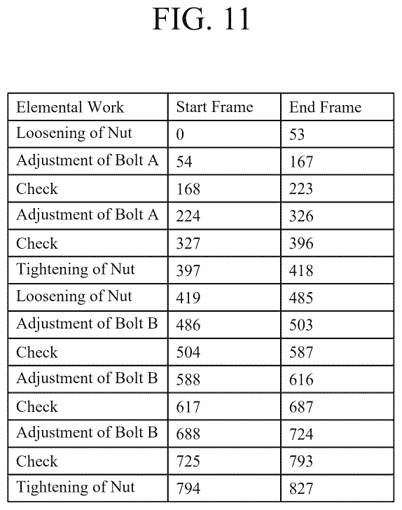

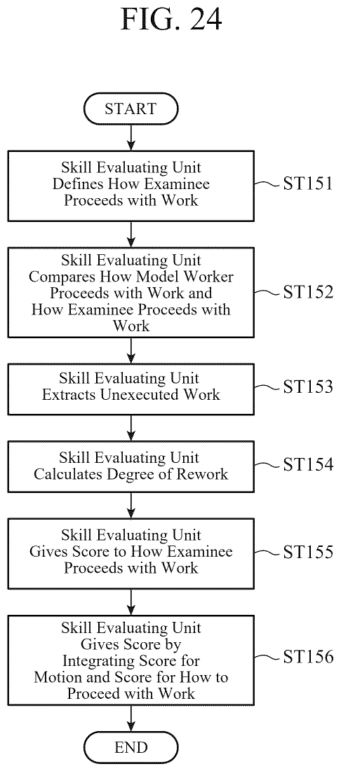

An operation of evaluating the examinee who has performed the work in the manner of proceeding with work at this point of time according to the work label data illustrated in FIG. 11 is described as an example. The processing flow is shown in FIG. 24.

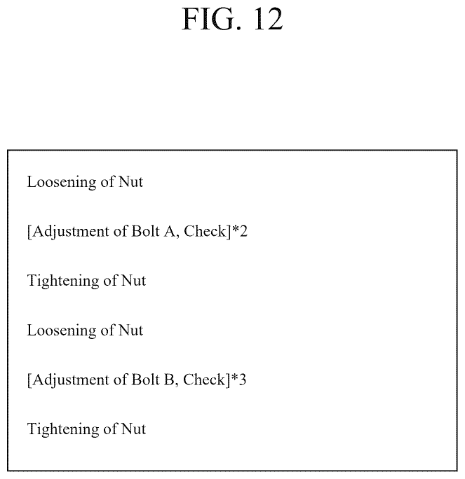

In ST151, how to proceed with work is extracted using the work label data of the examinee. In the case of the work label data illustrated in FIG. 11, how to proceed with work as illustrated in FIG. 12 is obtained by a process similar to the operation defining how the model worker proceeds with work in the model work analyzing unit 15 as described above.

In ST152, the model worker and the examinee are compared in terms of how to proceed with work.

In ST153, on the basis of the comparison result, a check is made to determine whether there is an unexecuted work, and, if there is, the unexecuted work is extracted. As for a method for extracting an unexecuted work, when there is an elemental work that is not defined in how the examinee proceeds with work among the elemental works defined in how the model worker proceeds with work, it is considered that a necessary elemental work is left unexecuted. Further, in a case where a range of the number of times is defined in how the model worker proceeds with work, if the work has been performed fewer times than the range of the number of times, it is also considered that there is an unexecuted work.

Specifically, how the model worker proceeds with work is acquired from the model work analyzing unit 15, so that the definition illustrated in FIG. 9A is obtained. By comparing how the model worker proceeds with work (FIG. 9A) with how the examinee proceeds with work (FIG. 12), the elemental work of the first “check” is extracted as an unexecuted work.

In ST154, the degree of rework is calculated on the basis of the result of the comparison between the model worker and the examinee in how to proceed with work. In a case where the method for extracting rework includes an elemental work that is not defined in how the model worker proceeds with work, it is considered that an unnecessary elemental work has been performed, which is regarded as rework. Also, in a case where a range of the number of times is defined in how the model worker proceeds with work, when the work has been performed the number of times or more in how the examinee proceeds with work, the examinee has not efficiently proceeded with work, and therefore, it is regarded as rework.

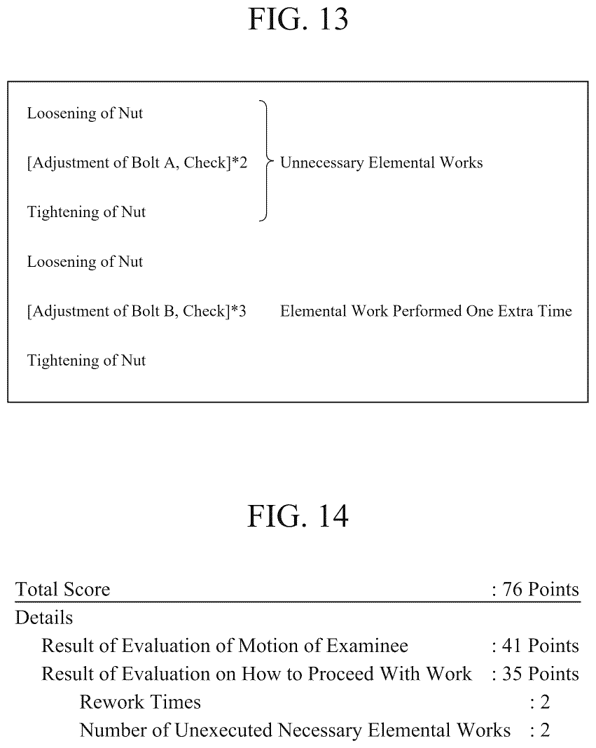

Specifically, an unnecessary elemental work related to the bolt A is extracted as rework as illustrated in FIG. 13 from the comparison between how the model worker proceeds with work (FIG. 9A) and how the examinee proceeds with work (FIG. 12). Also, the number of times the set of “adjustment of bolt B and check” has been performed is larger than that defined in how the model worker proceeds with work, which is regarded as rework.

In ST155, a score is given to how the examinee proceeds with work, on the basis of the results of ST153 and ST154. The larger the number of unexecuted works in the process in ST153, the lower the score. Further, the larger the number of items regarded as rework in the process in ST154, the lower the score. The distribution of scores in ST153 and ST154 can be changed as appropriate. Also, scoring may be performed, with importance being placed on a specific elemental work. Any scoring method may be adopted, and the scoring method is not limited to this.

In ST156, the score regarding the motion and the score regarding how to proceed with work are integrated, and a score is given. Specifically, the score (hereinafter referred to as the score A) regarding the motion calculated in ST144 in FIG. 23 is acquired, and the total points in the acquired score and the score (hereinafter referred to as the score B) regarding how to proceed with work calculated in ST155 in FIG. 24 is calculated. The method of calculating the total points may be any appropriate method, such as a method of calculating the average of the score A and the score B, or a method of weighting and adding the score A and the score B.

The results of evaluating the examinee (the total score, the score regarding the motion, and the score regarding how to proceed with work) are stored into the data storing unit 13 and is delivered to the evaluation result presenting unit 17.

The evaluation result presenting unit 17 presents, on a screen, a result of evaluating the examinee and information with which the difference between the model worker and the examinee is easy to understand, or outputs them to a file, using the result of the calculation performed by the skill evaluating unit 16 and the result of the analysis performed by the model work analyzing unit 15.

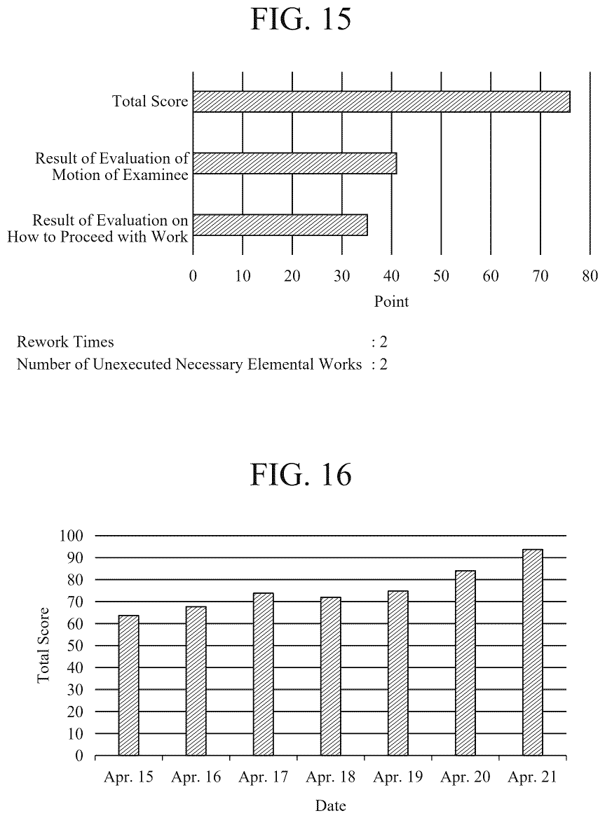

Examples of outputs of evaluation results are illustrated in FIGS. 14 to 16. In addition to the method of outputting text as illustrated in FIG. 14, there is a method of outputting as a graph as illustrated in FIG. 15. The output format, the type of graph, and the output contents are not limited thereto, and may be selected as appropriate. A result of similarity calculation may be output.

Further, as the past evaluation results are accumulated in the data storing unit 13, a learning process can be presented as illustrated in FIG. 16. Although FIGS. 15 and 16 are graphs indicating scores, the number of rework times, the number of unexecuted necessary works, similarity, or the like may be visualized.

FIGS. 14 to 16 are examples in which results of evaluation of one examinee are output, but results of evaluation of a plurality of persons may be output.

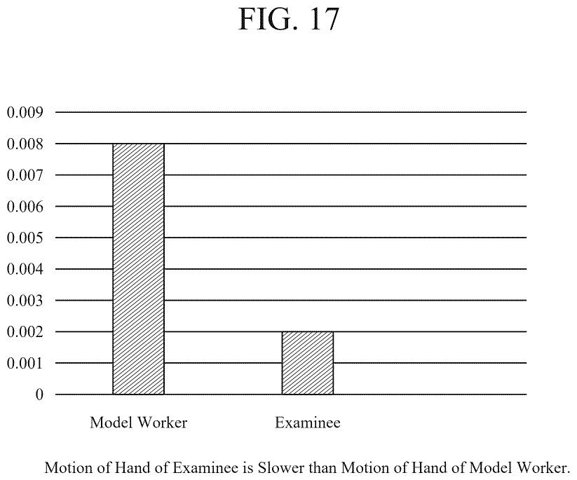

Also, as for information that makes it easier to understand the difference between the model worker and the examinee, it is possible to visualize and output an average value regarding an important feature amount, based on the important feature amounts extracted by the model work analyzing unit 15, the model range thereof, and the range of the value of the examinee. An example is illustrated in FIG. 17. For example, in a case where one of the feature amounts extracted by the model work analyzing unit 15 is the maximum value of the velocity of the palm, an average value of the maximum values of the velocities of the palm in a plurality of trials is calculated and visualized. Although the difference between the graphs is also output as text, the presence or absence of the text information is irrelevant herein. Also, the type of graph is not necessarily the bar graphs shown in FIG. 17.

FIG. 17 is an example of information in which the difference between the model worker and the examinee is easy to understand, but the information is not limited only to an average value regarding an important feature amount. An important feature amount and the model range thereof, and the range of the value of the examinee may be visualized.

Although FIG. 17 shows one type of important feature amount, graphs depending on types of important feature amounts can be output in a case where there is a plurality of types of important feature amounts.

Also, the results of the principal component analysis (the distribution of data in the feature space, which is illustrated as an example in FIG. 8) that has been output by the skill evaluating unit 16 may be presented on a screen. At the time of the output to the screen, information such as text can be added and output so that the difference between the model worker and the examinee can be easily understood. Alternatively, results other than the results of the principal component analysis may be presented.

In the first embodiment described above, the skill evaluation device 2 includes: the motion data acquiring unit 11 that acquires motion data indicating a motion of a work from the sensor 1 that detects the motion of the work being performed by an examinee in work skill evaluation; and the model work analyzing unit 15 that identifies an evaluation item important in evaluating the work of the examinee, on the basis of model-worker motion data indicating motions of a model worker. Also, the skill evaluation device 2 evaluates the skills of the examinee, on the basis of motion data acquired by the motion data acquiring unit 11 and the evaluation item identified by the model work analyzing unit 15. Thus, the skill evaluation device 2 can reduce degradation caused in skill evaluation results by a process of comparison between the motion of the examinee and the motion of the model worker for a motion other than important evaluation items.

### Second Embodiment

A second embodiment describes a skill evaluation device 2 including a working hand estimating unit 19 that estimates whether the hand mainly used by the examinee is the left hand or the right hand where the work is a manual work.

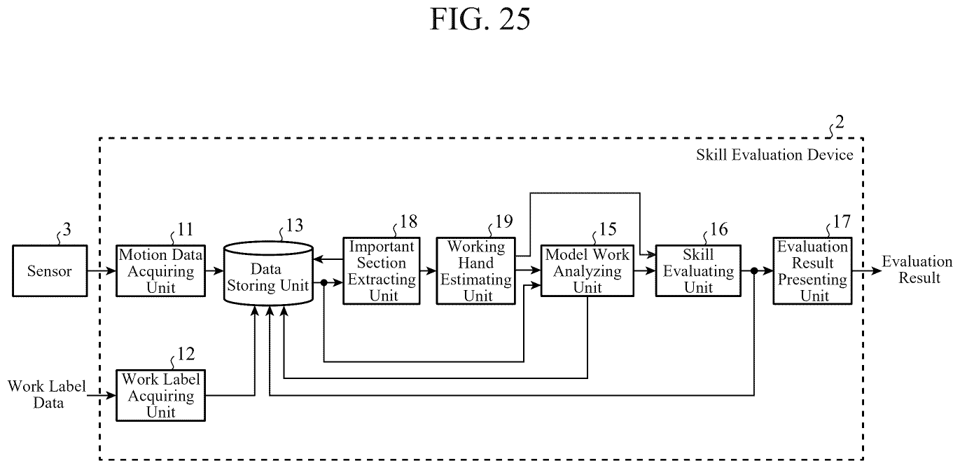

FIG. 25 is a configuration diagram showing the skill evaluation device 2 according to the second embodiment. In FIG. 25, the same reference numerals as those in FIG. 1 denote the same or corresponding components, and therefore, detailed explanation of them is not made herein.

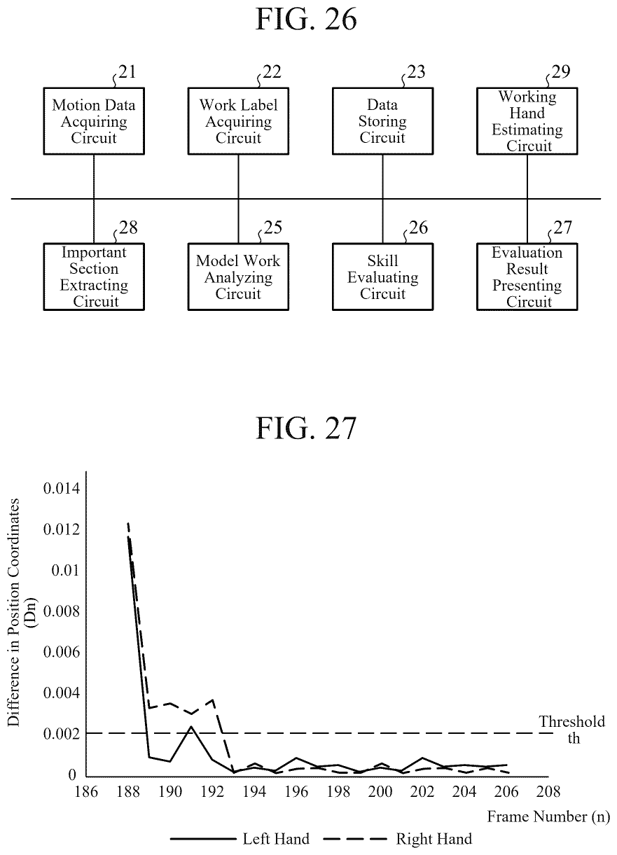

FIG. 26 is a hardware configuration diagram showing the hardware of the skill evaluation device 2 according to the second embodiment. In FIG. 26, the same reference numerals as those in FIG. 2 denote the same or corresponding components, and therefore, detailed explanation of them is not made herein.

In FIG. 25, a sensor 3 detects motions of the left hand and the right hand of a model worker, and outputs model-worker motion data indicating the motion of the left hand (hereinafter referred to as “model-worker's left-hand motion data”) and model-worker motion data indicating the motion of the right hand (hereinafter referred to as “model-worker's right-hand motion data”) to the skill evaluation device 2.

Also, the sensor 3 detects the respective motions of the left hand and the right hand of an examinee, and outputs motion data indicating the motion of the left hand (hereinafter referred to as “left-hand motion data”) and motion data indicating the motion of the right hand (hereinafter referred to as “right-hand motion data”) to the skill evaluation device 2.

The skill evaluation device 2 illustrated in FIG. 25 includes a motion data acquiring unit 11, a work label acquiring unit 12, a data storing unit 13, an important section extracting unit 18, the working hand estimating unit 19, a model work analyzing unit 15, a skill evaluating unit 16, and an evaluation result presenting unit 17.

In the skill evaluation device 2 illustrated in FIG. 25, the motion data acquiring unit 11 acquires each piece of the model-worker's left-hand motion data and the model-worker's right-hand motion data from the sensor 3, and outputs each piece of the model-worker's left-hand motion data and the model-worker's right-hand motion data to the data storing unit 13.

The motion data acquiring unit 11 acquires each piece of the left-hand motion data and the right-hand motion data from the sensor 3, and outputs each piece of the left-hand motion data and the right-hand motion data to the data storing unit 13.

In the skill evaluation device 2 illustrated in FIG. 25, the motion data acquiring unit 11 acquires each piece of the model-worker's left-hand motion data and the model-worker's right-hand motion data from the sensor 3. Note that this is merely an example, and the motion data acquiring unit 11 may acquire the model-worker's left-hand motion data from a sensor (not shown) that detects motions of the left hand of the model worker, and acquire the model-worker's right-hand motion data from a sensor (not shown) that detects motions of the right hand of the model worker.

Also, the motion data acquiring unit 11 acquires each piece of the left-hand motion data and the right-hand motion data from the sensor 3. Note that this is merely an example, and the motion data acquiring unit 11 may acquire the left-hand motion data from a sensor (not shown) that detects motions of the left hand of the examinee, and acquire the right-hand motion data from a sensor (not shown) that detects motions of the right hand of the examinee.

The important section extracting unit 18 is formed with an important section extracting circuit 28 shown in FIG. 26, for example.

The important section extracting unit 18 acquires, from the data storing unit 13, each piece of work label data of the model worker and work label data of the examinee.

The important section extracting unit 18 acquires, from the data storing unit 13, each piece of the model-worker's left-hand motion data and the model-worker's right-hand motion data of the model worker.

Also, the important section extracting unit 18 acquires, from the data storing unit 13, each piece of the left-hand motion data and the right-hand motion data of the examinee.

On the basis of the work label data of the model worker, the important section extracting unit 18 acquires the time sections in which the respective elemental works indicated by the model-worker's left-hand motion data of the model worker have been performed, and the time sections in which the respective elemental works indicated by the model-worker's right-hand motion data of the model worker have been performed.

Also, on the basis of the work label data of the examinee, the important section extracting unit 18 acquires the time sections in which the respective elemental works indicated by the left-hand motion data of the examinee have been performed, and the time sections in which the respective elemental works indicated by the right-hand motion data of the examinee have been performed.

On the basis of temporal changes in the motions of the respective elemental works indicated by the model-worker's left-hand motion data, the important section extracting unit 18 extracts, from the model-worker's left-hand motion data, model-worker's left-hand important-section motion data that is the model-worker's left-hand motion data in sections important in the respective elemental works.

The process to be performed by the important section extracting unit 18 to extract the model-worker's left-hand important-section motion data in the important sections is similar to the process to be performed by the important section extracting unit 14 shown in FIG. 1 to extract the model-worker motion data in the important sections.

Also, on the basis of temporal changes in the model motions of the respective elemental works indicated by the model-worker's right-hand motion data, the important section extracting unit 18 extracts, from the model-worker's right-hand motion data, model-worker's right-hand important-section motion data that is the model-worker motion data in the sections important in the respective elemental works.

The important section extracting unit 18 outputs each piece of the model-worker's left-hand important-section motion data and the model-worker's right-hand important-section motion data to the working hand estimating unit 19.

On the basis of temporal changes in the motions of the respective elemental works indicated by the left-hand motion data, the important section extracting unit 18 extracts, from the left-hand motion data, left-hand important-section motion data that is the left-hand motion data in the sections important in the respective elemental works.

Also, on the basis of temporal changes in the motions of the respective elemental works indicated by the right-hand motion data, the important section extracting unit 18 extracts, from the right-hand motion data, right-hand important-section motion data that is the right-hand motion data in the sections important in the respective elemental works.

The important section extracting unit 18 outputs each piece of the left-hand important-section motion data and the right-hand important-section motion data to the working hand estimating unit 19.

The working hand estimating unit 19 is formed with a working hand estimating circuit 29 shown in FIG. 26, for example.

The working hand estimating unit 19 acquires, from the important section extracting unit 18, each piece of the model-worker's left-hand important-section motion data, the model-worker's right-hand important-section motion data, the left-hand important-section motion data, the right-hand important-section motion data.

On the basis of the model-worker's left-hand important-section motion data and the model-worker's right-hand important-section motion data, the working hand estimating unit 19 estimates with which hand the model worker is mainly performing work, the left hand or the right hand.

The working hand estimating unit 19 outputs the model-worker's left-hand important-section motion data to the model work analyzing unit 15 when estimating that the model worker is working mainly with the left hand, and outputs the model-worker's right-hand important-section motion data to the model work analyzing unit 15 when estimating that the model worker is working mainly with the right hand.

Also, on the basis of the left-hand important-section motion data and the right-hand important-section motion data, the working hand estimating unit 19 estimates with which hand the examinee is mainly performing work, the left hand or the right hand.

The working hand estimating unit 19 outputs the left-hand important-section motion data to the skill evaluating unit 16 when estimating that the examinee is working mainly with the left hand, and outputs the right-hand important-section motion data to the skill evaluating unit 16 when estimating that the examinee is working mainly with the right hand.

In FIG. 25, it is assumed that the motion data acquiring unit 11, the work label acquiring unit 12, the data storing unit 13, the important section extracting unit 18, the working hand estimating unit 19, the model work analyzing unit 15, the skill evaluating unit 16, and the evaluation result presenting unit 17, which are components of the skill evaluation device 2, are formed with dedicated hardware as illustrated in FIG. 26. That is, it is assumed that the skill evaluation device 2 is formed with a motion data acquiring circuit 21, a work label acquiring circuit 22, a data storing circuit 23, the important section extracting circuit 28, the working hand estimating circuit 29, a model work analyzing circuit 25, a skill evaluating circuit 26, and an evaluation result presenting circuit 27.

Each of the motion data acquiring circuit 21, the work label acquiring circuit 22, the data storing circuit 23, the important section extracting circuit 28, the working hand estimating circuit 29, the model work analyzing circuit 25, the skill evaluating circuit 26, and the evaluation result presenting circuit 27 is a single circuit, a composite circuit, a programmed processor, a parallel-programmed processor, an ASIC, an FPGA, or a combination thereof, for example.

The components of the skill evaluation device 2 are not necessarily formed with dedicated hardware, but the skill evaluation device 2 may be formed with software, firmware, or a combination of software and firmware.

In a case where the skill evaluation device 2 is formed with software, firmware, or the like, the data storing unit 13 is formed in a memory 31 shown in FIG. 3. A program for causing a computer to execute each processing procedure in the motion data acquiring unit 11, the work label acquiring unit 12, the important section extracting unit 18, the working hand estimating unit 19, the model work analyzing unit 15, the skill evaluating unit 16, and the evaluation result presenting unit 17 is stored in the memory 31. The processor 32 shown in FIG. 3 then executes the program stored in the memory 31.

Further, FIG. 26 illustrates an example in which each of the components of the skill evaluation device 2 is formed with dedicated hardware, and FIG. 3 illustrates an example in which the skill evaluation device 2 is formed with software, firmware, or the like. Note that this is merely an example, and some components in the skill evaluation device 2 may be formed with dedicated hardware while the remaining components are formed with software, firmware, or the like.

Next, operations to be performed by the skill evaluation device 2 illustrated in FIG. 25 are described.

Like the important section extracting unit 14 shown in FIG. 1, the important section extracting unit 18 extracts the model-worker motion data in sections important in the respective elemental works, from the model-worker motion data of the model worker.

Note that, unlike the important section extracting unit 14 shown in FIG. 1, the important section extracting unit 18 extracts, from the model-worker motion data of the left hand of the model worker, the left-hand important-section motion data that is the model-worker motion data in the sections important in the respective elemental works.

Also, the important section extracting unit 18 extracts, from the model-worker motion data of the right hand of the model worker, the right-hand important-section motion data that is the model-worker motion data in the sections important in the respective elemental works.

The important section extracting unit 18 outputs each piece of the left-hand important-section motion data and the right-hand important-section motion data to the working hand estimating unit 19.

FIG. 27 illustrates a specific example in a case where the important section extracting unit 18 extracts the left-hand important-section motion data and the right-hand important-section motion data.

FIG. 27 illustrates results of calculation in ST101 of the displacement of the position coordinates of the palms of the left and right hands in the previous frame, for a time section related to the label of “adjustment of bolt B” in the work label data shown in FIG. 5A. In a case where the threshold is set to 0.002, and the predetermined frames are set to two frames, the window is shifted one frame at a time by a window size of two frames from the start frame 188 of the work label data, and a position where all the two frames in the window are smaller than the threshold is searched for. Here, a and b represent the respective window sizes of the two frames. All the frames in the target window are equal to or smaller than the threshold at the position of frame 192 for the left hand and the position of frame 193 for the right hand, and therefore, the start position of an important section is determined to be the position of frame 193, by combining the results from the right hand and the left hand. In a case where the start position differs between the left and right hands in this manner, one of them can be adjusted.

In ST103, the end position of the important section is determined to be the position of the last frame among the predetermined number of successive frames in which the result calculated in ST101 is smaller than the threshold, while the window is shifted one frame at a time from the last frame toward the top frame. This is a process in which the search direction is reverse to that in ST102, and the search method is the same as that in ST102.

In FIG. 27, all the values in the window are smaller than the threshold in the first window (the window of frames 204 to 206), and accordingly, the end position of the important section is determined to be frame 206.

Although a processing flow has been described using the label “adjustment of bolt B” as an example in the above description, the important section is extracted in the same manner as above for each elemental work corresponding to one row of the work label data regarding the other elemental works.

Note that, in the above example operation, the difference from the position coordinates in the previous frame is calculated using the position coordinates of the palms of the left and right hands in ST101. However, the variables to be used are not limited to the palms. Also, the value to be calculated is not necessarily a difference in position coordinates.

The working hand estimating unit 19 calculates a feature amount of each of the left and right hands using the sections extracted by the important section extracting unit 18, and estimates which hand is performing work in each elemental work (at each time in a case where the same elemental work is performed a plurality of times), the right hand or the left hand.

The hand that is performing work is the hand that is mainly moving, and, in the work of tightening a nut, for example, the hand that is tightening the nut is the hand that is performing work. In the case of a work in which both hands are moved to the same extent, both hands are the hands that are performing work.

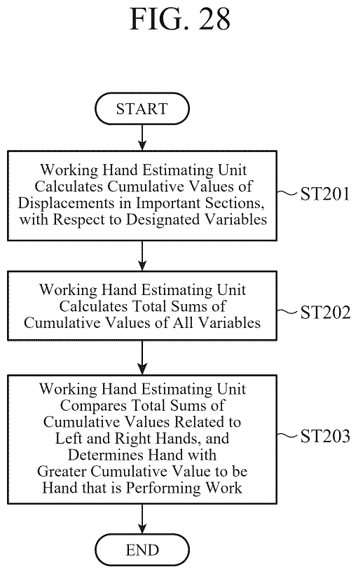

A processing flow in a case where the sum of the cumulative values of displacements is used as a feature amount is shown in FIG. 28.

In ST201, a cumulative value of displacements in an important section is calculated regarding a designated variable.

Specifically, an important section extracted by the important section extracting unit 18 is received, the absolute value of the difference in the designated variable from the position coordinates of the previous frame in the important section is calculated, and the absolute value is added in the entire important section to calculate the cumulative value. The variable may be one type such as “palm”, or a plurality of variables such as “palm” and “wrist” can be used. When the palm and the wrist are used, cumulative values of displacements of the palms (the two types of the right hand and the left hand) and cumulative values of displacements of the wrist (two types of the right hand and the left hand) are calculated.

In ST201, the sums of the cumulative values of all variables are calculated. When one type of variable is used, the result is the same as the result of ST201. When the two variables of palm and wrist are used in ST201, the cumulative value related to the palm and the cumulative value related to the wrist are added for the right hand to obtain a sum. Likewise, for the left hand, the cumulative value related to the palm and the cumulative value related to the wrist are added to obtain a sum.

In ST203, the sums of the cumulative values calculated in ST202 are compared between the left and right hands, and the hand with the greater cumulative value is regarded as the working hand.

In the above example operation, an operation using the sums of cumulative values as the feature amounts has been described. However, the feature amounts are not limited to the sums of cumulative values, and any other appropriate feature amounts can be used.

The result from the working hand estimating unit 19 is stored into the data storing unit 13, and is delivered to the model work analyzing unit 15.

When any model-worker important-section motion data out of the model-worker's left-hand important-section motion data and the model-worker's right-hand important-section motion data is output from the working hand estimating unit 19, the model work analyzing unit 15 acquires the model-worker important-section motion data as the model-worker motion data.

When both the model-worker's left-hand important-section motion data and the model-worker's right-hand important-section motion data are output from the working hand estimating unit 19, the model work analyzing unit 15 acquires both the model-worker's left-hand important-section motion data and the model-worker's right-hand important-section motion data as the model-worker motion data.

The model work analyzing unit 15 identifies evaluation items important in evaluating the work of the examinee, on the basis of the model-worker motion data, as in the first embodiment.

Specifically, when the method a for extracting important feature amounts using the model-worker motion data of one model worker is used, the feature amounts are calculated in ST111 in FIG. 19 for the important section in each trial of the target elemental work (for each row of the work label data) using the acquired model-worker motion data and work label data of a plurality of maintenance works. As an example of the feature amounts, statistics (a maximum value, a minimum value, and the like) with respect to position, velocity, or the like are calculated using an arbitrary variable. However, the feature amounts are not limited thereto, and any appropriate feature amounts can be used.

“Each trial of the target elemental work” corresponds to each row in the work label data of the target elemental work. For example, when the target elemental work is “adjustment of bolt B” in a case where the work label data of FIG. 5A is used, the feature amounts are calculated for the important section extracted by the important section extracting unit 14 for each (each trial) of the first adjustment (from frame 188 to frame 206) and the second adjustment (from frame 325 to frame 405).

As a specific example of the feature amounts, in a case where feature amounts related to the velocity of a palm are calculated, for example, the velocity is calculated on the basis of the difference from the previous frame using the position coordinates of the palm in an important section of the target trial, and the maximum value, the minimum value, and the like of the velocity in the important section are calculated as the feature amounts. The calculation is performed for each of the left and right hands.

In ST112, a standard deviation in the plurality of trials is calculated for each feature amount calculated in ST111.

For example, in a case where the work label data in FIG. 5A is used, when the target elemental work is “adjustment of bolt B”, feature amounts are obtained from trial data of a total of two sets of the feature amounts calculated from the important section of the first adjustment (from frame 188 to frame 206) and the feature amounts calculated from the important section of the second adjustment (from frame 325 to frame 405) (sets of feature amounts in two trials are obtained).

Likewise, in a case where the work label data in another maintenance work is the data in FIG. 5B, feature amounts related to “adjustment of bolt B” are obtained from trial data of a total of two sets of the feature amounts calculated from the important section of the first adjustment (from frame 174 to frame 198) and the feature amounts calculated from the important section of the second adjustment (from frame 327 to frame 386). In this manner, in a case where the work label data (FIGS. 5A and 5B) of two maintenance works is used, feature amounts of four trials are obtained with respect to “adjustment of bolt B”.

In ST112, standard deviations in a plurality of trials are calculated using the result of the working hand estimated by the working hand estimating unit 19, with the working hand in each trial being taken into consideration. For example, when the hand performing the work in the first adjustment in FIG. 5A and the first adjustment in FIG. 5B is estimated to be the right hand, and the hand performing the work in the second adjustment in FIG. 5A and the second adjustment in FIG. 5B is estimated to be the left hand, the standard deviations in four trials are calculated using the data of the right hand for the feature amounts obtained from the first adjustment in FIG. 5A and the first adjustment in FIG. 5B, and using the data of the left hand for the feature amounts obtained from the second adjustment in FIG. 5A and the second adjustment in FIG. 5B. In another case, when the hand performing the work is estimated to be the right hand by the working hand estimating unit 19 in all the trials (four times) in FIGS. 5A and 5B, the standard deviations are calculated using the feature amounts obtained from the right hand in all the four trials. In this manner, the hand that is performing work and the hand that is not performing work are distinguished from each other, and the standard deviations are calculated using the feature amounts related to the hand in each trial, depending on which hand is to be analyzed.

In ST113, feature amounts with less variation are extracted in the plurality of trials, and are regarded as important feature amounts that are evaluation items important in terms of work. As the feature amounts with less variation, feature amounts whose standard deviations calculated in ST112 are equal to or smaller than a threshold are extracted. The threshold is defined in a setting file, or is given by an input through a mouse, a keyboard, or the like. Any other method may be used.

In ST114, a check is made to determine whether there is an important feature amount. In a case where standard deviations are used, if there are no feature amounts whose standard deviations are equal to or smaller than the threshold, it is determined that there are no important feature amounts, and there are no evaluation items important in terms of work (ST116).

If there is an important feature amount, a model range of the important feature amount is extracted from the model-worker motion data of the model worker in ST115. For example, in a case where the important feature amount is the “maximum value of the palm velocity”, a possible range (from the minimum value to the maximum value) of the “maximum value of the palm velocity” is acquired from the model-worker motion data of the target model worker used in the analysis, and the range is set as the model range of the important feature amount. Model ranges are extracted on the basis of the number of important feature amounts and each important feature amount. Note that, in a case where the hand performing work in the plurality of trials to be analyzed in ST112 is a mix of the right and left hands, when an important feature amount, such as an angle or the like, that is interpreted differently between the left and right hands, a model range is calculated for each of the left and right hands.

Although an example operation of extracting an important feature amount related to the hand performing work has been described above, the feature amounts with less variation can also be extracted in a plurality of trials with respect to the hand that is not performing work, and important feature amounts can be extracted. When there is an important feature amount, a model range thereof is extracted.

In this manner, the important evaluation items in terms of work are obtained from the analysis of the model worker of the model worker.

Although an example operation of extracting an important feature amount related to the hand performing work has been described above, the feature amounts with less variation can also be extracted in a plurality of trials with respect to the hand that is not performing work, and important feature amounts can be extracted. When there is an important feature amount, a model range thereof is extracted.

As for the hand that is not performing work, there are cases where pressing with the hand or touching with the hand is performed even if the hand is not moved like the hand that is performing work, and there are cases where the point of the work is present in the motion. Therefore, the same operation as above is performed.

Further, the above example operation is an example operation in which it is determined that there are no important feature amounts when there are no feature amounts whose standard deviations are equal to or smaller than the threshold in ST116, but the determination method is not limited to this method. By another method, the number of feature amounts whose standard deviations are equal to or smaller than the threshold may be obtained, and it may be determined that there are no important feature amounts when the number is small (equal to or smaller than a threshold).

Alternatively, a method that does not use standard deviations may be adopted.

The process to be performed by the model work analyzing unit 15 to extract the important feature amounts using the model-worker motion data of a plurality of model workers is the same as that in the first embodiment.

Also, in the model work analyzing unit 15, the definition of how to proceed with work is the same as that in the first embodiment.

The skill evaluating unit 16 acquires important evaluation items from the model work analyzing unit 15.

When any important-section motion data out of the left-hand important-section motion data and the right-hand important-section motion data is output from the working hand estimating unit 19, the skill evaluating unit 16 acquires the important-section motion data as the motion data.

When both the left-hand important-section motion data and the right-hand important-section motion data is output from the working hand estimating unit 19, the skill evaluating unit 16 acquires both the left-hand important-section motion data and the right-hand important-section motion data as the motion data.

The skill evaluating unit 16 evaluates the skills of the examinee, on the basis of the model-worker motion data regarding the evaluation items and the motion data regarding the evaluation item, as in the first embodiment.

Specifically, in the case of the method a by which evaluation is performed using the model range of an important feature amount extracted by the model work analyzing unit 15, a score calculating system is created using the model range of the important feature amount in ST131 in FIG. 22.

In the example in FIG. 7, when one of the important feature amounts extracted by the model work analyzing unit 15 is “important feature amount A”, and the model range extracted by the model work analyzing unit 15 is from v1 to v2, scores are calculated by roughly dividing the levels into three stages. When the score is closer to the model range of the important feature amount A, the motion is regarded as being closer to the model motion, and level 1, level 2, and level 3 are defined in descending order of scores. For example, 100 points are given at level 1, which is the model range, 80 points are given at level 2, which is close to the model range, and a score is calculated in the range at level 3 using an attenuation function so that the score is lower at a position farther away from the model range. Width δ can be set to any appropriate value.

The method of calculating a score is not limited to the above method. For example, scoring can be performed by two determinations as to pass/fail, such as passing (100 points) when the range of the important feature amount is the model range, and failing (0 points) when the range is some other range.

Also, as for a range other than the model range from v1 to v2 of the important feature amount, the score may be calculated so that the score is lower at a position farther away from the model range.

Further, a range other than the model range from v1 to v2 of the important feature amount may be divided into four ranges, and five-grade evaluation in total may be performed. The score calculation method and the level division may be other than the above.

In ST132, a value of the important feature amount obtained from the model worker is calculated using motion data of the examinee. Specifically, the motion data acquiring unit 11 acquires motion data of the examinee, the work label acquiring unit 12 acquires the work label data corresponding to the model-worker motion data, the important section extracting unit 14 extracts sections important in terms of work (important sections), and the working hand estimating unit 19 acquires the hand that is mainly performing the work. Specific operations and the details of the processes are the same as those described above. Using these results, the value of each important feature amount in the important sections is calculated in each trial of the elemental work.

For example, in a case where there are two types of important feature amounts, which are the maximum value of the velocity of the palm and the minimum value of the velocity of the palm, the values of these two types of feature amounts in the important sections are calculated using the model-worker motion data of the model worker.

In ST133, a score for the examinee is calculated, on the basis of the score calculating system created in ST131.

For example, in a case where the value of the important feature amount A calculated from motion data of the examinee corresponds to level 1 in FIG. 7 (within the range from v1 to v2), 100 points are given. A score is calculated for each of the hand that is performing the work and the hand that is not performing the work, and an average value is calculated.

Next, in a case where the method b for vectorizing and evaluating important feature amounts extracted by the model work analyzing unit 15 is used, a value of an important feature amount obtained from the model worker is calculated using the motion data of the examinee in ST141 in FIG. 23. The process and the details of the operation are the same as those in ST132 in FIG. 22.

In ST142, feature vectors having important feature amounts as components are generated, and the similarity between the model worker and the examinee is calculated. For example, in a case where the important feature amounts are the two types of the maximum value of the velocity of the palm and the minimum value of the velocity of the palm, feature vectors having these two types of values as components are generated for both the model worker and the examinee, and the cosine similarity between the feature vectors is calculated.

In ST143, principal component analysis is performed using the calculation result of the important feature amounts in the data of the model worker and the examinee, and the similarity between the model worker and the examinee is calculated on the basis of the degree of separation of the data in the feature space.

An example is now described with reference to FIG. 8. FIG. 8 illustrates an example in which calculation results of important feature amounts for the model worker and the examinee are standardized and subjected to principal component analysis, and a first principal component is plotted on the x-axis while a second principal component is plotted on the y-axis. Round marks indicate results of the model worker, and square marks indicate results of the examinee. The results of each worker is trial data of four trials. The results of calculation of the important feature amounts are acquired from the model work analyzing unit 15. As for the examinee, the results are acquired in ST141.

As a method of calculating the degree of separation of data in the feature space in which the first principal component is the x-axis while the second principal component is the y-axis, it is possible to use a method based on the distance between the center of gravity of the plurality of pieces of data of the model worker and the center of gravity of a plurality of pieces of data of the examinee, a method based on the point at which the distance between the data of the model worker and the data of the examinee is shortest, a method based on the point at which the distance between the data of the model worker and the data of the examinee is longest, a method of combining two or more of these methods, or the like. The similarity between the model worker and the examinee is calculated on the basis of the degree of separation of data in the feature space by a method of performing calculation to set the similarity to 1.0 when the distance is equal to or shorter than a threshold, and set the similarity to a value that is smaller when the distance is longer, or by a method of performing calculation to set the similarity to a value that is smaller when the distance is longer, without setting any threshold.

In ST144, scoring is performed on the basis of the similarities calculated in ST142 and ST143. For example, the average score can be calculated by giving scores to the similarities in ST142 and ST143, with the maximum of similarity based on ST142 being M points, the maximum of similarity based on ST143 being N points. As another method, there is a method of calculating an average of the similarity calculated in ST142 and the similarity calculated in ST143, and giving scores to the calculation results on the basis of a similarity maximum of 1.0.

In FIG. 8, the operation of giving a score to the motion of the examinee using two types of the similarity (ST142) calculated using the feature vector and the similarity (ST143) calculated from the result of the principal component analysis has been described. However, the similarity is not limited to the above two types, and some other methods can be used. Further, it is not necessary to use both of the two types, and it is possible to use only one of the two types. Alternatively, similarities may be calculated by some other methods, and results of similarities calculated by three or more kinds of methods may be taken into consideration.

Furthermore, the method of giving scores to similarities in ST144 is not limited to the above-described method.

Next, evaluation regarding how to proceed with work in the skill evaluating unit 16 is described.

In the example described below, there are two types of targets to be subjected to maintenance work, which are the bolt A and the bolt B, and the examinee adjusts both the bolt A and the bolt B, though the work of adjusting only the bolt B is correct.

The model manner of proceeding with work is shown in FIG. 9A, which is assumed to be how to proceed with work defined from the work label data of the model worker shown in FIG. 5A. By a model method of proceeding with work, a check is first performed, a nut is then loosened, a set of “adjustment of bolt B and check” is performed twice, and the nut is tightened.

An operation of evaluating the examinee who has performed the work in the manner of proceeding with work at this point of time according to the work label data illustrated in FIG. 11 is described as an example. The processing flow is shown in FIG. 24.

In ST151, how to proceed with work is extracted using the work label data of the examinee. In the case of the work label data illustrated in FIG. 11, how to proceed with work as illustrated in FIG. 12 is obtained by a process similar to the operation defining how the model worker proceeds with work in the model work analyzing unit 15 as described above.

In ST152, the model worker and the examinee are compared in terms of how to proceed with work.

In ST153, on the basis of the comparison result, a check is made to determine whether there is an unexecuted work, and, if there is, the unexecuted work is extracted. As for a method for extracting an unexecuted work, when there is an elemental work that is not defined in how the examinee proceeds with work among the elemental works defined in how the model worker proceeds with work, it is considered that a necessary elemental work is left unexecuted. Further, in a case where a range of the number of times is defined in how the model worker proceeds with work, if the work has been performed fewer times than the range of the number of times, it is also considered that there is an unexecuted work.

Specifically, how the model worker proceeds with work is acquired from the model work analyzing unit 15, so that the definition illustrated in FIG. 9A is obtained. By comparing how the model worker proceeds with work (FIG. 9A) with how the examinee proceeds with work (FIG. 12), the elemental work of the first “check” is extracted as an unexecuted work.

In ST154, the degree of rework is calculated on the basis of the result of the comparison between the model worker and the examinee in how to proceed with work. In a case where the method for extracting rework includes an elemental work that is not defined in how the model worker proceeds with work, it is considered that an unnecessary elemental work has been performed, which is regarded as rework. Also, in a case where a range of the number of times is defined in how the model worker proceeds with work, when the work has been performed the number of times or more in how the examinee proceeds with work, the examinee has not efficiently proceeded with work, and therefore, it is regarded as rework.

Specifically, an unnecessary elemental work related to the bolt A is extracted as rework as illustrated in FIG. 13 from the comparison between how the model worker proceeds with work (FIG. 9A) and how the examinee proceeds with work (FIG. 12). Also, the number of times the set of “adjustment of bolt B and check” has been performed is larger than that defined in how the model worker proceeds with work, which is regarded as rework.

In ST155, a score is given to how the examinee proceeds with work, on the basis of the results of ST153 and ST154. The larger the number of unexecuted works in the process in ST153, the lower the score. Further, the larger the number of items regarded as rework in the process in ST154, the lower the score. The distribution of scores in ST153 and ST154 can be changed as appropriate. Also, scoring may be performed, with importance being placed on a specific elemental work. Any scoring method may be adopted, and the scoring method is not limited to this.

In ST156, the score regarding the motion and the score regarding how to proceed with work are integrated, and a score is given. Specifically, the score (hereinafter referred to as the score A) regarding the motion calculated in ST144 in FIG. 23 is acquired, and the total points in the acquired score and the score (hereinafter referred to as the score B) regarding how to proceed with work calculated in ST155 in FIG. 24 is calculated. The method of calculating the total points may be any appropriate method, such as a method of calculating the average of the score A and the score B, or a method of weighting and adding the score A and the score B.

The results of evaluating the examinee (the total score, the score regarding the motion, and the score regarding how to proceed with work) are stored into the data storing unit 13 and is delivered to the evaluation result presenting unit 17.

In the second embodiment described above, the work is a manual work, and the motion data acquiring unit 11 acquires, from the sensor 3, the motion data indicating the motion of the left hand of the examinee, and the motion data indicating the motion of the right hand of the examinee. The important section extracting unit 18 then extracts the left-hand important-section motion data, which is the motion data in the sections important in the work, from the motion data indicating the motion of the left hand, on the basis of temporal change in the motion data indicating the motion of the left hand acquired by the motion data acquiring unit 11, and extracts the right-hand important-section motion data, which is the motion data in the sections important in the work, from the motion data indicating the motion of the right hand, on the basis of temporal change in the motion data indicating the motion of the right hand acquired by the motion data acquiring unit 11. The skill evaluation device 2 illustrated in FIG. 24 includes the working hand estimating unit 19 that estimates with which hand the examinee is mainly performing work, the left hand or the right hand, on the basis of the left-hand important-section motion data and the right-hand important-section motion data extracted by the important section extracting unit 18, outputs the left-hand important-section motion data to the skill evaluating unit 16 when the hand with which the examinee is mainly performing work is estimated to be the left hand, and outputs the right-hand important-section motion data to the skill evaluating unit 16 when the hand with which the examinee is mainly performing work is estimated to be the right hand. Accordingly, like the skill evaluation device 2 illustrated in FIG. 1, the skill evaluation device 2 illustrated in FIG. 24 can reduce the degradation to be caused in the results of skill evaluation by the process of comparison between the motion of the examinee and the motion of the model worker in terms of motions other than those of the important evaluation items, and can evaluate the skills of the examinee even when the dominant hand of the examinee is unknown. Also, even in the case of the same type of elemental works, it is possible to evaluate the skills of an examinee even who uses a different hand to perform work in each trial. Further, even in a case where the hand mainly with which the model worker is performing work differs from the hand mainly with which the examinee is performing work, evaluation can be performed by comparing skills.

### Third Embodiment

In a third embodiment, a skill evaluation device 2 including a designated feature amount acquiring unit 41 that acquires a designated feature amount that is a feature amount to be analyzed is described.

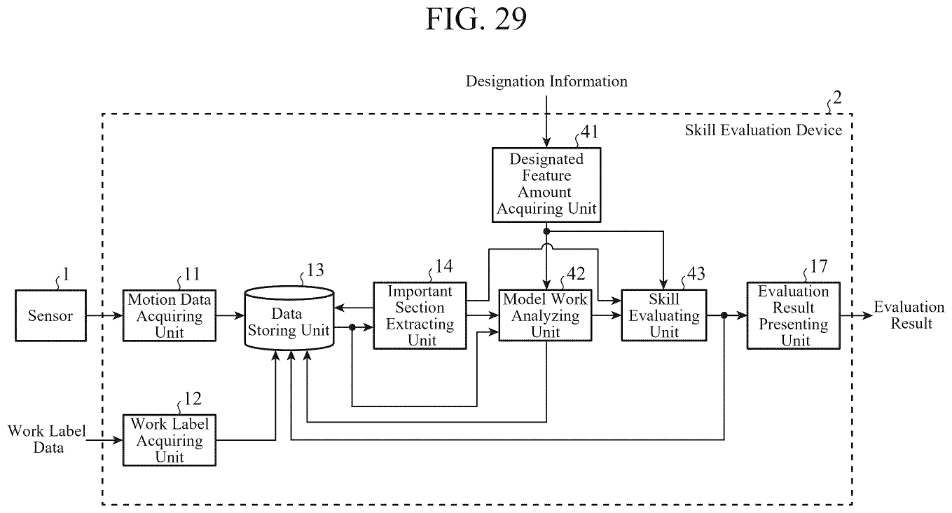

FIG. 29 is a configuration diagram showing the skill evaluation device 2 according to the third embodiment. In FIG. 29, the same reference numerals as those in FIG. 1 and FIG. 25 denote the same or corresponding components, and therefore, detailed explanation of them is not made herein.

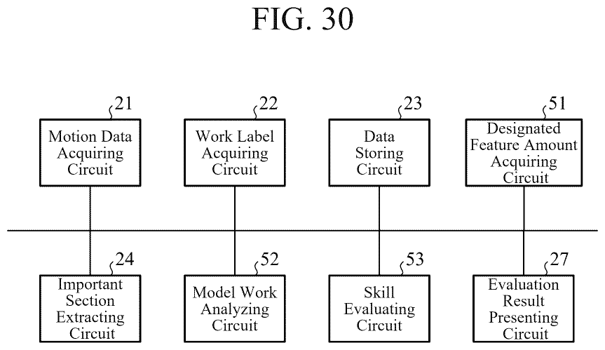

FIG. 30 is a hardware configuration diagram showing the hardware of the skill evaluation device 2 according to the third embodiment. In FIG. 30, the same reference numerals as those in FIG. 2 and FIG. 26 denote the same or corresponding components, and therefore, detailed explanation of them is not made herein.

The skill evaluation device 2 illustrated in FIG. 29 includes a motion data acquiring unit 11, a work label acquiring unit 12, a data storing unit 13, an important section extracting unit 14, the designated feature amount acquiring unit 41, a model work analyzing unit 42, a skill evaluating unit 43, and an evaluation result presenting unit 17.

The designated feature amount acquiring unit 41 is formed with a designated feature amount acquiring circuit 51 shown in FIG. 30, for example.

The designated feature amount acquiring unit 41 accepts a designated feature amount when the designated feature amount that is a feature amount of the analysis target is given from a man-machine interface (not shown) that can be operated by the user, for example. The man-machine interface is an interface such as a keyboard, a mouse, a touch panel, or a microphone.

The designated feature amount acquiring unit 41 outputs the designated feature amount to both the model work analyzing unit 42 and the skill evaluating unit 43.

In the skill evaluation device 2 illustrated in FIG. 29, the designated feature amount acquiring unit 41 acquires the designated feature amount from the man-machine interface. Note that this is merely an example, and the designated feature amount acquiring unit 41 may receive a designated feature amount via a communication device (not shown).

The model work analyzing unit 42 is formed with a model work analyzing circuit 52 shown in FIG. 30, for example.

The model work analyzing unit 42 acquires, from the important section extracting unit 14, the model-worker motion data in the sections important in the respective elemental works.

Also, the model work analyzing unit 42 acquires the designated feature amount from the designated feature amount acquiring unit 41.

Like the model work analyzing unit 15 shown in FIG. 1, the model work analyzing unit 42 identifies evaluation items important in evaluating the work of the examinee, on the basis of the model-worker motion data, and outputs the important evaluation items to the skill evaluating unit 43.

Like the model work analyzing unit 15 shown in FIG. 1, the model work analyzing unit 42 calculates important feature amounts that are the feature amounts regarding the motions for the evaluation items indicated by the model-worker motion data.

The model work analyzing unit 42 outputs the important feature amounts to the skill evaluating unit 43.

The skill evaluating unit 43 is formed with a skill evaluating circuit 53 shown in FIG. 30, for example.

The skill evaluating unit 43 acquires the motion data from the important section extracting unit 14.

Also, the skill evaluating unit 43 acquires the designated feature amount from the designated feature amount acquiring unit 41, and acquires the important evaluation items from the model work analyzing unit 42.

The skill evaluating unit 43 calculates important feature amounts that are the feature amounts regarding the motions for the evaluation items indicated by the motion data.

The skill evaluating unit 43 evaluates the skills of the examinee, on the basis of the feature amounts calculated by the model work analyzing unit 42, the feature amounts related to the motion indicated by the motion data, and the designated feature amount.

The skill evaluating unit 43 outputs the skill evaluation result to both the evaluation result presenting unit 17 and the data storing unit 13.

In the skill evaluation device 2 illustrated in FIG. 29, the designated feature amount acquiring unit 41, the model work analyzing unit 42, and the skill evaluating unit 43 are applied to the skill evaluation device 2 illustrated in FIG. 1. Note that this is merely an example, and the designated feature amount acquiring unit 41, the model work analyzing unit 42, and the skill evaluating unit 43 may be applied to the skill evaluation device 2 illustrated in FIG. 25.

In FIG. 29, it is assumed that the motion data acquiring unit 11, the work label acquiring unit 12, the data storing unit 13, the important section extracting unit 14, the designated feature amount acquiring unit 41, the model work analyzing unit 42, the skill evaluating unit 43, and the evaluation result presenting unit 17, which are components of the skill evaluation device 2, are formed with dedicated hardware as illustrated in FIG. 30. That is, it is assumed that the skill evaluation device 2 is formed with a motion data acquiring circuit 21, a work label acquiring circuit 22, a data storing circuit 23, an important section extracting circuit 24, the designated feature amount acquiring circuit 51, the model work analyzing circuit 52, the skill evaluating circuit 53, and an evaluation result presenting circuit 27.

Each of the motion data acquiring circuit 21, the work label acquiring circuit 22, the data storing circuit 23, the important section extracting circuit 24, the designated feature amount acquiring circuit 51, the model work analyzing circuit 52, the skill evaluating circuit 53, and the evaluation result presenting circuit 27 is a single circuit, a composite circuit, a programmed processor, a parallel-programmed processor, an ASIC, an FPGA, or a combination thereof, for example.

The components of the skill evaluation device 2 are not necessarily formed with dedicated hardware, but the skill evaluation device 2 may be formed with software, firmware, or a combination of software and firmware.

In a case where the skill evaluation device 2 is formed with software, firmware, or the like, the data storing unit 13 is formed in a memory 31 shown in FIG. 3. A program for causing a computer to execute each processing procedure in the motion data acquiring unit 11, the work label acquiring unit 12, the important section extracting unit 14, the designated feature amount acquiring unit 41, the model work analyzing unit 42, the skill evaluating unit 43, and the evaluation result presenting unit 17 is stored in the memory 31 shown in FIG. 3. The processor 32 shown in FIG. 3 then executes the program stored in the memory 31.

Further, FIG. 30 illustrates an example in which each of the components of the skill evaluation device 2 is formed with dedicated hardware, and FIG. 3 illustrates an example in which the skill evaluation device 2 is formed with software, firmware, or the like. Note that this is merely an example, and some components in the skill evaluation device 2 may be formed with dedicated hardware while the remaining components are formed with software, firmware, or the like.

Next, operations to be performed by the skill evaluation device 2 illustrated in FIG. 29 are described.

The details of the respective processes and specific operations to be performed by the motion data acquiring unit 11, the work label acquiring unit 12, and the important section extracting unit 14 are the same as those in the first embodiment.

The designated feature amount acquiring unit 41 acquires a feature amount to be analyzed. The feature amount to be analyzed is defined in a setting file beforehand by the user, and it is possible to acquire the feature amount by reading the setting file. For example, in a case where the velocity of a palm is to be used, information about the palm and the velocity is defined beforehand.

Other than a method of acquiring information from a setting file, a method of inputting information with a mouse, a keyboard, voice, or the like may be adopted. The acquired feature amount is delivered to the model work analyzing unit 42 and the skill evaluating unit 43.

The model work analyzing unit 42 extracts a feature amount with less variation in the plurality of trials, and extracts feature amounts (important feature amounts) related to evaluation items important in terms of work.

As described in the first embodiment, there are the following two types of methods for extracting important feature amounts.

a. A method of extraction from the model-worker motion data and the work label data of one model worker b. A method of extraction from the model-worker motion data and the work label data of a plurality of model workers

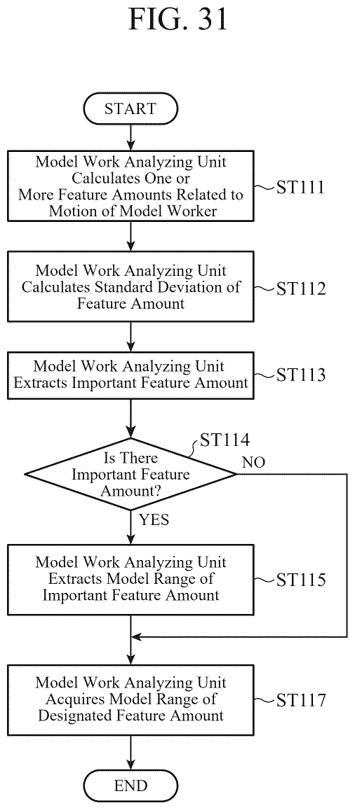

A processing flow according to a method of extracting important feature amounts using data of one model worker by the above method a is shown in FIG. 31. The same processes as those in FIG. 19 to be performed by the model work analyzing unit 15 of the first embodiment (in a case where data of one model worker is used) are denoted by the same reference numerals as those in FIG. 19.

In ST117, a model range of the designated feature amount acquired by the designated feature amount acquiring unit 41 is acquired using the data of the model worker. Also, in a case where there are no important feature amounts, the process in ST117 for acquiring a model range of the designated feature amount is performed.

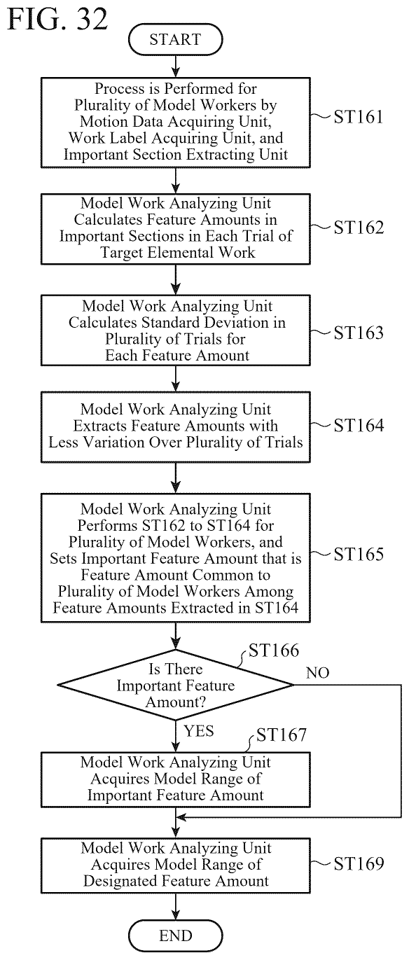

A processing flow according to a method of extracting important feature amounts using data of a plurality of model workers by the above method b is shown in FIG. 32. The same processes as those in FIG. 20 to be performed by the model work analyzing unit 15 of the first embodiment (in a case where data of a plurality of model workers is used) are denoted by the same reference numerals as those in FIG. 20. ST169 is added, and a model range of the designated feature amount acquired by the designated feature amount acquiring unit 41 is acquired with respect to the plurality of model workers.

The types of the important feature amounts and the designated feature amount, and the result of acquisition of the model range are delivered to the skill evaluating unit 43.

The skill evaluating unit 43 quantitatively evaluates the skills of the examinee, on the basis of motion evaluation using the motion analysis result (evaluation items important in terms of work) extracted by the model work analyzing unit 42, and evaluation on how to proceed with work using a result of analysis on how to proceed with work (a model manner for proceeding with work) as extracted by the model work analyzing unit 42.

In the motion evaluation, a process is performed using the designated feature amount in addition to the important feature amounts, in contrast to the examples (a method of evaluation using a model range of an important feature amount, and a method of evaluation by vectorizing important feature amounts) described in the first embodiment.

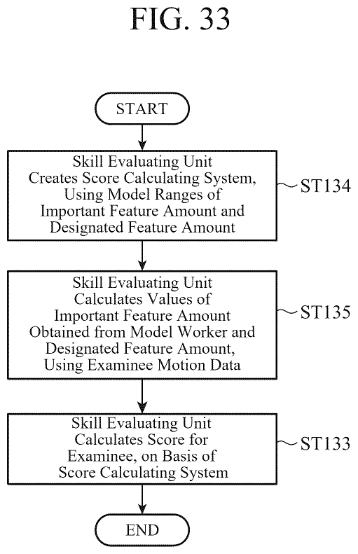

A processing flow according to a method of calculating a score using model ranges of important feature amounts and a designated feature amount is shown in FIG. 33. The same processes as those in the operation (FIG. 22) in the case of using only the important feature amounts in the first embodiment are denoted by the same numbers.

In ST134, a score calculating system is created using the model ranges of the important feature amounts and the designated feature amount. Although only the important feature amounts are used in the first embodiment, the processes are the same as those of the first embodiment, except that the designated feature amount is also used.

In ST135, values of the important feature amounts obtained from the model worker and the designated feature amount are calculated using the motion data of the examinee. Although only the important feature amounts are used in the first embodiment, the processes are the same as those of the first embodiment, except that the designated feature amount is also used.

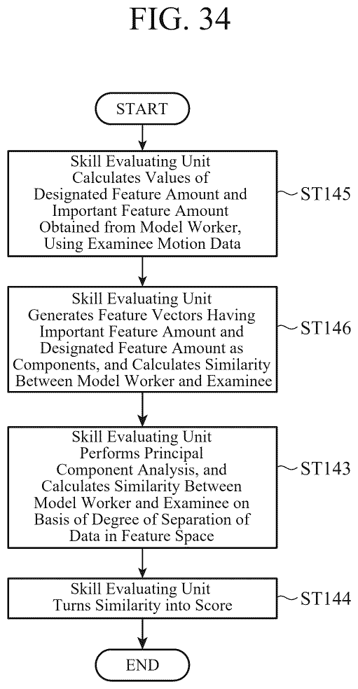

Further, a processing flow according to a method of vectorizing and evaluating the important feature amounts and the designated feature amount regarding the motion evaluation is shown in FIG. 34. The same processes as those in the processing flow according to the first embodiment (FIG. 23) are denoted by the same numbers.

In ST145, values of the designated feature amount and the important feature amounts obtained from the model worker are calculated using the motion data of the examinee. Although only the important feature amounts are used in the first embodiment, the designated feature amount is also used in the third embodiment.

In ST146, feature vectors having important feature amounts and the designated feature amount as components are generated, and the similarity between the model worker and the examinee is calculated. Although only the important feature amounts are used in the first embodiment, the designated feature amount is also used in the third embodiment.

The result of the evaluation by the skill evaluating unit 43 is stored into the data storing unit 13, and is delivered to the evaluation result presenting unit 17.

The details of the processes and the specific operations to be performed by the evaluation result presenting unit 17 are similar to those in the first embodiment.

### Fourth Embodiment

The skill evaluation device 2 illustrated in FIG. 1 includes the skill evaluating unit 16. Note that this is merely an example, and the skill evaluating unit 16 may be provided outside the skill evaluation device 2.

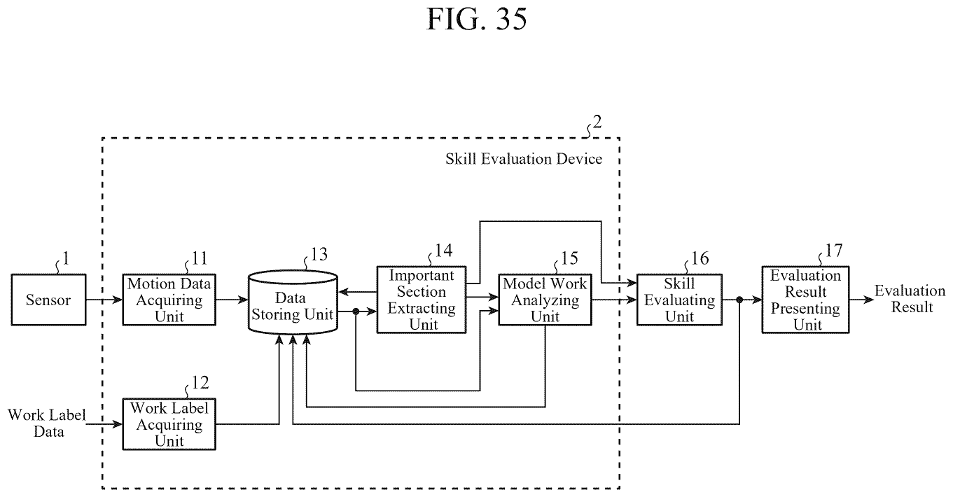

FIG. 35 is a configuration diagram showing a skill evaluation device 2 according to a fourth embodiment. In FIG. 35, the same reference numerals as those in FIG. 1, FIG. 25, and FIG. 29 denote the same or corresponding components, and therefore, detailed explanation of them is not made herein.

The skill evaluation device 2 illustrated in FIG. 35 does not include the skill evaluating unit 16 and the evaluation result presenting unit 17.

Either the motion data acquiring unit 11 or the important section extracting unit 14 of the skill evaluation device 2 illustrated in FIG. 35 outputs motion data to the skill evaluating unit 16 provided outside the skill evaluation device 2.

The model work analyzing unit 15 of the skill evaluation device 2 illustrated in FIG. 35 outputs evaluation items to the skill evaluating unit 16 provided outside the skill evaluation device 2.

The operations to be performed by the motion data acquiring unit 11, the work label acquiring unit 12, the data storing unit 13, the important section extracting unit 14, and the model work analyzing unit 15 included in the skill evaluation device 2 illustrated in FIG. 35 are the same as the respective operations to be performed by the motion data acquiring unit 11, the work label acquiring unit 12, the data storing unit 13, the important section extracting unit 14, and the model work analyzing unit 15 included in the skill evaluation device 2 illustrated in FIG. 1.

The skill evaluation device 2 illustrated in FIG. 35 according to the fourth embodiment is obtained by removing both the skill evaluating unit 16 and the evaluation result presenting unit 17 from the skill evaluation device 2 illustrated in FIG. 1. Note that this is merely an example, and the skill evaluation device 2 according to the fourth embodiment may be obtained by removing both the skill evaluating unit 16 and the evaluation result presenting unit 17 from the skill evaluation device 2 illustrated in FIG. 25, or may be obtained by removing the designated feature amount acquiring unit 41, the skill evaluating unit 43, and the evaluation result presenting unit 17 from the skill evaluation device 2 illustrated in FIG. 29.

In the fourth embodiment described above, the skill evaluation device 2 includes: the motion data acquiring unit 11 that acquires motion data indicating a motion of a work from the sensor 1 that detects the motion of the work being performed by an examinee in work skill evaluation; and the model work analyzing unit 15 that identifies an evaluation item important in evaluating the work of the examinee, on the basis of model-worker motion data indicating motions of a model worker, in which the model work analyzing unit 15 outputs the identified evaluation item to the skill evaluating unit 16. Accordingly, like the skill evaluation device 2 illustrated in FIG. 1, the skill evaluation device 2 illustrated in FIG. 35 can reduce the degradation to be caused in the results of skill evaluation by the process of comparison between the motion of the examinee and the motion of the model worker in terms of motions other than those of important evaluation items.

In the first to fourth embodiments, a plurality of pieces of data of motion data and work label data is stored in a database, but is not necessarily stored in the form of a database. The method of storing a plurality of pieces of motion data and work data may be any appropriate method.

In the first to fourth embodiments, example operations in which the model work analyzing unit 15 or the like extracts the feature amounts whose standard deviations are equal to or smaller than a threshold as the feature amounts with less variation have been described. However, the method of extracting the feature amounts with less variation is not necessarily a method using standard deviations. Instead of standard deviations, values obtained by dividing standard deviations by average values can also be used. Further, any other appropriate method may be used.

In the first to fourth embodiments, examples in which motions related to a manual work are analyzed have been described with the work of adjusting a bolt taken as an example. However, the body parts to be analyzed are not limited to the hand. Some other body parts such as the head, the foot, and the elbow can be evaluated as the evaluation target in the same manner as above. The configuration of the device in a case where a body part other than the hand is to be evaluated is a configuration obtained by removing the “working hand estimating unit 19” from the configuration of the device illustrated in FIG. 25.

In the first to fourth embodiments, it is assumed that a time section in which a hand or the head is being moved before reaching a fixed position is included between the start frame and the end frame defined by work label data, and the important section extracting unit 14 and the like are designed to exclude the time section before the fixed position. However, in a case where the work label data that defines the start frame and the end frame while excluding the time section in which the hand or the head is being moved before reaching the fixed position is used, a configuration from which the important section extracting unit 14 and the like are excluded is used. The configuration in this case is a configuration obtained by removing the important section extracting unit 14 and the like from one of the devices illustrated in FIGS. 1, 25, 29, and 35.

In the first to fourth embodiments, example operations in which the model work analyzing unit 15 and the like use the motion data and the work label data of a plurality of maintenance works performed by a model worker have been described. However, this can also be applied in a case where there are only the motion data and the work label data of one maintenance work.

In the first to fourth embodiments, example operations of calculating similarity using cosine similarity and a result of principal component analysis have been described. However, the method of calculating similarity is not limited to this.

In the first to fourth embodiments, in the motion evaluation performed by the skill evaluating unit 16 and the like, a score is calculated for each of the hand that is performing work and the hand that is not performing work in the example operations described above. However, a score may be given only to one of the hands. Also, the scores for the hand that is performing work and the hand that is not performing work may be weighted and added. In a case where the score for the working hand and the score for the non-working hand are separated, the evaluation result presenting unit 17 can separate the score for the working hand and the score for the non-working hand from each other, and output the separate scores to a screen or a file.

In the first to fourth embodiments, example operations in which evaluation is performed by the skill evaluating unit 16 or the like integrating the evaluation regarding motions and the evaluation regarding how to proceed with work have been described. However, only the evaluation regarding motions or only the evaluation regarding how to proceed with work can be presented (or output to a file) as a final evaluation result.

In the first to fourth embodiments, example operations in which the information for facilitating the understanding of the difference between the model worker and the examinee is presented by the skill evaluating unit 16 or the like have been described. However, only the work points obtained from the analysis of the motion of the model worker and how the model worker proceeds with work may be output to a screen or a file, without including any result of evaluation of the examinee. In the first to fourth embodiments, a maintenance work for adjusting a bolt has been described as an example. However, the work to be evaluated is not necessarily adjustment of a bolt, and is not necessarily a maintenance work. The embodiments can be applied to various other works (works in a production line, maintenance works, inspection works, manual works such as traditional craft, daily works, and the like).

Note that, in the present disclosure, it is possible to freely combine the respective embodiments, modify any of the components in each of the embodiments, or omit any of the components in each of the embodiments.

### INDUSTRIAL APPLICABILITY

The present disclosure is suitable for a skill evaluation device and a skill evaluation method.

### REFERENCE SIGNS LIST

1: sensor, 2: skill evaluation device, 3: sensor, 11: motion data acquiring unit, 12: work label acquiring unit, 13: data storing unit, 14: important section extracting unit, 15: model work analyzing unit, 16: skill evaluating unit, 17: evaluation result presenting unit, 18: important section extracting unit, 19: working hand estimating unit, 21: motion data acquiring circuit, 22: work label acquiring circuit, 23: data storing circuit, 24: important section extracting circuit, 25: model work analyzing circuit, 26: skill evaluating circuit, 27: evaluation result presenting circuit, 28: important section extracting circuit, 29: working hand estimating circuit, 31: memory, 32: processor, 41: designated feature amount acquiring unit, 42: model work analyzing unit, 43: skill evaluating unit, 51: designated feature amount acquiring circuit, 52: model work analyzing circuit, 53: skill evaluating circuit

1. A skill evaluation device comprising:
processing circuitry configured to
acquire motion data indicating motions of works, acquired by a sensor that detects the motions of the works;
extract respective values of first feature amounts from the acquired motion data indicating each of the plural works by a model worker and identify a first feature amount that is an evaluation item for evaluating a skill of an examinee, on a basis of variation in respective values of extracted first feature amounts; and
evaluate the skill of the examinee, on a basis of the acquired motion data on the works of the model worker, the acquired motion data on the works of the examinee, and the identified first feature amount, and
wherein the processing circuitry acquires the motion data indicating motions of the works of each model worker at plural times for each of a plurality of model workers, and
wherein the processing circuitry extracts feature amounts with less variation for each model worker from the plural pieces of the motion data of each of the plurality of model workers and identifies a feature amount common to the plurality of model workers from the extracted feature amount as the first feature amount.

2. The skill evaluation device according to claim 1,
wherein the processing circuitry is further configured to
extract motion data in a section important in the work from the acquired motion data;
extract a value of each feature amount of the extracted motion data corresponding to the section important in the work and indicating each of the works at plural times performed by the model workers and identifies the first feature amount that is the evaluation item;
evaluate the skill of the examinee, on a basis of the value of the first feature amount extracted from the motion data on the works performed by the model workers and the value of the first feature amount extracted from the motion data on the works performed by the examinee; and
extract a start position and an end position of the important section on a basis of a position where a change in position coordinates of body parts of the motion data of the model worker is constantly less than a threshold in a predetermined time and extracts motion data in a section ranging from the start position to the end position as the motion data in the section important in the work.

3. The skill evaluation device according to claim 2, wherein
the processor circuitry is configured to evaluate how to proceed with work by the examinee as the skill of the examinee, on a basis of presence or absence of execution of a necessary elemental work and presence or absence of rework, and
the processor circuitry is configured to determine, as the rework, a work corresponding to any one of works in a case where an elemental work not included in the motion data of the model worker is included in the motion data of the examinee,
where an elemental work of a target device being different from another target device indicated by the motion data of the model worker, out of a plurality of target devices, is included in the motion data of the examinee, or
where an elemental work whose number of repetitions is greater than the number of repetitions of an elemental work that is repeated and indicated by the motion data of the model worker is included in the motion data of the examinee.

4. The skill evaluation device according to claim 1
wherein the processor circuitry is configured to present a quantitative evaluation result with regard to motions for each elemental work and a quantitative evaluation result with regard to how to proceed work based on presence or absence of execution of a necessary elemental work and presence or absence of rework, as a result of skill evaluation, and present them by visualizing a difference between the examinee and the model worker based on these evaluation results.

5. A skill evaluation method performed by a skill evaluation device, comprising:
acquiring motion data indicating motions of works, acquired by a sensor that detects the motions of the works;
extracting respective values of first feature amounts from the acquired motion data indicating each of the plural works by a model worker and identifying a first feature amount that is an evaluation item for evaluating a skill of an examinee, on a basis of variation in respective values of extracted first feature amounts;
evaluating the skill of the examinee, on a basis of the acquired motion data on the works of the model worker, the acquired motion data on the works of the examinee and the identified first feature amount;
acquiring the motion data indicating motions of the works of each model worker at plural times for each of a plurality of model workers; and
extracting feature amounts with less variation for each model worker from the plural pieces of the motion data of each of the plurality of model workers and identifying a feature amount common to the plurality of model workers from the extracted feature amount as the first feature amount.

6. A non-transitory computer readable medium with an executable program stored thereon, wherein the program instructs a computer to perform:
acquiring motion data indicating motions of works, acquired by a sensor that detects the motions of the works;
extracting respective values of first feature amounts from the acquired motion data indicating each of the plural works by a model worker and identifying a first feature amount that is an evaluation item for evaluating a skill of an examinee, on a basis of variation in respective values of extracted first feature amounts;
evaluating the skill of the examinee, on a basis of the acquired motion data on the works of the model worker, the acquired motion data on the works of the examinee, and the identified first feature amount;
acquiring the motion data indicating motions of the works of each model worker at plural times for each of a plurality of model workers; and
extracting feature amounts with less variation for each model worker from the plural pieces of the motion data of each of the plurality of model workers and identifying a feature amount common to the plurality of model workers from the extracted feature amount as the first feature amount.
